(19) United States
(12) Patent Application Publication
(10) Pub. No.: US 2015/0000193 A1
(43) Pub. Date: Jan. 1, 2015

(54) Planter for hybrid container-gardening system

(71) Applicant: Christopher R. Cantolino, Sarasota, FL (US)

(72) Inventor: Christopher R. Cantolino, Sarasota, FL (US)

(21) Appl. No.: 13/987,021

(22) Filed: Jun. 26, 2013

(51) Int. Cl. A01G 27/00

(52) U.S. Cl. CPC A01G 27/005
USPC 47/79

(57) ABSTRACT

A low-maintenance and water-conserving container-gardening system used indoors or outdoors to grow plants, vegetables, herbs, fruits, and flowers. Combining the advantages/benefits of natural bacteria-enriched soil with the advantages/benefits of hydroponics to feed plant roots oxygenated nutrient/fluid precisely at the time of need, the system uses one or more gardening containers each having water-elevating structure causing slow and consistent upward flow of nutrient/fluid into the soil, and nutrient/fluid drainage-facilitating structure that directs surplus nutrient/fluid away from plant roots when the pump stops. Support for gardening containers includes nutrient/fluid reservoirs and frames, with multiple gardening containers optionally connected together in stepped gravity-feed arrangements. Use of renewable energy is preferred, and solar-assist may be employed with timers and pumps. System advantages include optional compact configurations for porch/balcony/patio use, moderated root temperature, longer growing seasons, multiple harvests, provisions for rainwater reservoir replenishment, and use of commonly-available, inexpensive, and locally-sourced soils, nutrients, and filtration media.

### BACKGROUND

1. Field of the Invention

This invention relates to container-gardening systems, specifically to a water-conserving and low-maintenance hybrid container-gardening system that can be used outdoors or indoors to grow a variety of plants, vegetables, herbs, fruits, and flowers. It combines the advantages and benefits of natural bacteria-enriched soil with the advantages and benefits of hydroponics to feed plant roots oxygenated nutrient/fluid precisely at the time of need for optimal root/plant growth, and it preferably also uses timers and renewable energy to accomplish this. Present invention structure includes the combination of reservoir, pump, fluid transport line, and one or more gardening containers each having water-elevating structure that causes a slow and consistent flow of oxygenated nutrient/fluid in an upwardly direction through soil to plant roots until soil saturation occurs, after which drainage-facilitating structure in the areas of soil-fluid interface and elsewhere in each present invention gardening container diverts surplus nutrient/fluid (newly incoming nutrient/fluid and that already present in the gardening container which is not immediately needed for plant growth) away from plant roots to prevent the plant stunting and disease-promoting impact that stagnant nutrient/fluid could otherwise have on plant roots after the pump stops. Furthermore, to prevent soil infiltration and blockage of fluid flow within the present invention system, including blockage of the nutrient/fluid transport lines connected between adjacent gardening containers, each present invention gardening container also has at least one peripheral channel providing a soil-fluid interface for uptake of nutrient/fluid by plant roots, while the remaining fluid-flow-assisting structure therein (including a main channel) has shielded protection against soil infiltration during its use for management of surplus nutrient/fluid entering the gardening containers after fluid saturation of soil in the peripheral channel or channels occurs. Gardening containers in preferred embodiments of the present invention hybrid system may be connected to one another in multiple stepped gravity-feed arrangements, have non-stepped arrangement relative to others having the same or similar support, be supported with or without stepped gravity-feed arrangement or connection to one another upon a strength-enhanced and sturdy reservoir and its cover, be supported by a modular frame that permits simple and easy system expansion to include the temporary or permanent addition of more gardening containers when needed, be supported by an elevated frame with or without sufficient height to provide underneath storage for one or more nutrient/fluid supply reservoirs, or a combination thereof in a variety of arrangements. Advantages of the present invention include compact and portable configurations suited for porch/balcony/patio use, larger configurations usable for more diverse residential food and herb production than the compact configurations, controlled/moderated root temperature during root/plant growth that helps to extend growing seasons even as seasonal increases or decreases in temperature occur, reservoir cover structure allowing rainwater replenishment of a nutrient/fluid supply reservoir supporting one or more gardening containers, and use of inexpensive soils, nutrients, and filtration media that are commonly-available from local suppliers instead of requiring operators to purchase special-order/dedicated supplies and filtration media.

2. Description of the Prior Art

Although soil gardening, hydroponics gardening, and container-gardening are all known, and each has been widely used, the present invention is the first known plant growing system adapted for families and homeowners that combines the most advantageous benefits of all three. In addition to being low-maintenance, optionally portable, and water-conserving, it is also able to use commonly-available, inexpensive, and locally-sourced soils, nutrients, and filtration media. Furthermore, it is easy to assemble, modular in form for easy and low-cost expansion, and has a design adaptable for providing compact and efficient embodiments for porch, small patio, and balcony use. In addition, it can be prepared to be self-sustaining for a minimum time period of approximately one month, wherein it promotes optimal root/plant growth while reducing owner maintenance. Multiple gardening containers can be connected together into a stepped gravity-feed arrangement, supported at the same or different elevations by a frame or a nutrient/fluid reservoir, and timers and solar-assist may be employed to allow system operation only on renewable energy. System advantages include, but are not limited to, consistent nutrient/fluid supply to all plants for augmented plant growth and increased vegetable/fruit production, moderated root temperature that helps to extend growing seasons and allow multiple harvests, optional compact configuration for porch/balcony use, and an option for rainwater replenishment of reservoirs.

The advantages of soil gardening include an option of providing differing amounts of moisture, temperature, and sunlight according to plant needs. Thus, a soil garden may grow only one type of plant, or in the alternative have various mixed arrangements of differing plants having similar moisture, temperature, and sunlight requirements. Soil gardening also provides a mixture of organic matter in varying stages of decomposition, air, water, and mineral particles (such as sand, clay, and silt), which together assist in maintaining a good balance of moisture and air around plant roots. In addition, soil may contain bacteria, fungi, protozoa, and earthworms, which further break down substances in the soil into nutrients that the plants growing therein can use. Soil also acts as a buffer around plant roots to help maintain nutrients in the root zone, while moderating the temperature around plant roots and isolating them from destructive pests. In addition, soil cannot be easily over saturated with water. In contrast, the advantages of hydroponics include recycled water, which reduces water cost. In addition, since no soil is used, nutrient levels can be better controlled, which reduces nutrient cost. Hydroponics gardening also maintains high plant/crop yields, is easy to harvest, containers are typically movable which assists in disease, weed, and pest control, and pesticide use is generally not required. The inventions thought to be the closest to the present invention are aquaponics systems that allow the complementary growth of plants and fish in different containers with fluid flow between them. The fish are fed in one container with water containing waste from the fish being cycled into the container holding plants, wherein bacteria in the plant container breaks down the fish waste for plant root uptake, with the decontaminated water (without fish waste) then being recycled back to the fish container. The main differences between the present invention and such aquaponics systems include removal in present invention systems of surplus nutrient/fluid from around plant roots each night, fluid-management structure in the bottom portion of present invention gardening containers that also creates oxygenation of nutrient/fluid delivered to plant roots, and use of soil (the aquaponics systems use gravel or other non-soil media to support plant roots). No prior art container-gardening system for plants is known to have structure similar to that of the present invention, to function in the same manner as the present invention, or to provide all of its advantages, including the combined advantages/benefits of soil gardening and hydroponics that provides plants with all of the nutrients they need precisely at the time they need it, with concurrent drainage of surplus nutrient/fluid away from plant roots once soil saturation occurs that avoids stunted plant growth and disease that could otherwise impact plants having roots exposed to stagnant nutrient/fluid.

While some of the prior art may contain some similarities relating to the present invention, none of them teach, suggest or include all of the advantages and unique features of the invention disclosed hereunder.

### SUMMARY OF THE INVENTION

It is the primary object of this invention to provide a container-gardening system that combines the advantages and benefits of soil gardening with the advantages and benefits of hydroponics to present a near constant flow of oxygenated nutrient/fluid to the roots of plants grown therein that optimizes root/plant growth, while minimizing stagnant nutrient/fluid near roots that stunts plant growth and facilitates plant/root disease. A further object of this invention is to provide a container-gardening system that is easy to use, space-saving, optionally portable, low-maintenance, easy-to-maintain, and water-conserving. It is also an object of this invention to provide a container-gardening system that can use commonly-available, inexpensive, and locally-sourced soils, nutrients, and filtration media. Another object of this invention is to provide a container-gardening system with gardening containers that can be used independently with a reservoir, be connected to at least one other gardening container while all gardening containers, are supported by a reservoir/tank or an independent frame at a single elevation, or be connected together in a stepped gravity-feed arrangement while all gardening containers are supported by the reservoir/tank or an independent frame. It is also an object of this invention to provide a container-gardening system that is fast and easy to install, has a stable configuration once installed, and requires minimal post-installation inspection and maintenance. It is a further object of this invention to provide a container-gardening system that can extend the growing season for most plants, and allows multiple harvests in the same year or season for selected plants. In addition, it is a further object of the present invention to provide a container-gardening system made from crack-resistant, corrosion-resistant, UV-resistant, fire-resistant, and extremely durable materials that resist premature deterioration and malfunction, as well as have resistance to temperature extremes. It is also an object of this invention to provide a container-gardening system that can be downsized and otherwise adapted for porch and balcony use, and has a provision for rainwater reservoir replenishment. A further object of this invention is to provide a container-gardening system that can be self-sustaining for minimum time periods of approximately one month, while continuing during that time period to provide optimal root/plant growth.

The present invention, when properly made and used, provides a hybrid system for growing plants that includes a nutrient/fluid supply reservoir and one or more gardening containers each having at least one area of soil-fluid interface that provides consistent flow of oxygenated nutrient/fluid to plant roots, while remaining nutrient/fluid movement areas within each gardening container are shielded from soil infiltration to prevent blockages that could interfere with drainage of surplus nutrient/fluid away from plant roots or prevent surplus nutrient/fluid from being available for recycled use. Multiple gardening containers can be connected together to provide a stepped and non-stepped gravity-feed arrangements, whether support for them is provided by a reservoir/cover or an independent frame. Inclined structure for gravity-feed can be integrated into the bottom of the gardening container, provided by the reservoir/cover or frame, or provided by a combination of both. Timers and solar-assist may be also employed, and are preferred. Since the system is a hybrid of soil gardening and hydroponics, advantages include low maintenance, consistent nutrient supply to all plants without the risk of over fertilization as the soil is not easily oversaturated, root temperature is moderated by the continual flow of nutrient/fluid until soil saturation which provides augmented plant growth and improved crop yields over plants grown in prior art container-gardening systems, due to root temperature moderation extended growing seasons are possible and the rewards of multiple harvests can also be enjoyed. Compact configurations of the present invention are adaptable for porch/balcony use, and the present invention may use of commonly-available, inexpensive, and locally-sourced soils, nutrients, and filtration media instead of special-order/dedicated supplies and filtration media. Rainwater may also supplement filtered and recycled nutrient/fluid. One or more obstructions are strategically placed within each gardening container to create a waterfall effect (turbulence) for recycled nutrient/fluid to oxygenate it for enhanced plant/root growth, which may be an integrated part of the soil-blocking shield over the main channel. Raised pads, in combination with the pockets created between them in present invention gardening containers, also slow nutrient/fluid travel in peripheral channels and prevent too much nutrient/fluid from jumping upwardly into soil-filled areas overly-saturating plant roots. After timers are shut off, the soil in a present invention gardening container acts like a sponge to draw up nutrient/fluid from the pockets and prevent fluid stagnation risk. Also, a plate or other obstruction associated with the channel prior to nutrient/fluid exit from each gardening container allows nutrient/fluid to jump over it, but not any soil, as a further preventive measure to avoid the clogging of nutrient/fluid transport lines used for fluid communication between gardening containers. The nutrient/fluid supply reservoir used as a part of the present invention can be selected to contain a 30-day supply of nutrient/fluid needed for optimal plant growth and crop yields, so that once the system is set up, the owner can walk away for 30 days with confidence that advantageous system operation will continue. Limiting factors are the size and shape of the space available to house the present invention system (porch, balcony, patio, back yard), the number of gardening containers used and the vertical drop needed for good nutrient/fluid flow from each gardening container to the next lower gardening container in a stepped gravity-feed system of connected gardening containers, and the size of the pump used in a stepped gravity-feed system of connected gardening containers for lifting the nutrient/fluid to the gardening container having the highest vertical elevation. System advantages include consistent nutrients supplied to all plants for better plant growth and food production, use of non-dedicated soil, nutrients, and water conditioning supplies that are readily and widely available from local suppliers, and gardening container structure that promotes non-clogging nutrient/fluid flow.

Although the description herein provides several preferred embodiments of the present invention, they should be considered as exemplary and not limiting to its scope. For example, variations in the number of gardening containers and reservoirs used; the size of the reservoir used; the type of soil-blocking shield used over the main channel as long as it fulfills its soil-blocking function; the size and number of raised pads used as a part of the soil-fluid interface in the peripheral channels, the configuration of strength-enhancing structure in the walls of gardening containers and reservoirs as long as the walls remain strong during their use; the means by which oxygenation of nutrient/fluid occurs and whether more than one oxygenation source is used; whether an independent frame or reservoir is used for support of the gardening containers, or a combination thereof is used; whether the inclines needed for gravity-feed nutrient/fluid flow are provided by structure integrated into the bottom of gardening containers or provided by external gardening container supports; whether the fluid flow through the gardening containers is end-to-end or has another path that facilitates nutrient/fluid uptake by plant roots; the size of the pump used; and the number of solar power generating units used; other than those shown and described herein, may be incorporated into the present invention. Thus, the scope of the present invention should be determined by the appended claims and their legal equivalents, rather than being limited to the examples given.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a perspective view from the front of a first preferred embodiment of the present invention hybrid container-gardening system showing two gardening containers at the same elevation supported upon the removable cover of a nutrient/fluid reservoir, a solar power generating unit upon a support that is secured by mounts in the reservoir and its cover, and each gardening container having independent fluid communication with the reservoir and a drain/outlet opening in its bottom surface that transfers surplus nutrient/fluid not needed by plants grown therein directly into the reservoir for recycling.

FIG. 2 is a perspective view from the rear of the invention in FIG. 1, and showing the preferred connection of the solar power generating unit to its support and the support extending through a mount in the reservoir cover, a vertically-extending tube with a float also extending through the reservoir cover, two gardening containers each having a soil-blocking shield positioned over a portion of its bottom surface, an independent nutrient/fluid line extending from the reservoir to each gardening container, strength enhancing features in the reservoir and gardening container walls, and an access opening in the reservoir cover between the gardening containers under a removable plate that provides quick access to pump and filtering apparatus positioned within the reservoir.

FIG. 3 is a section view from the side of the invention in FIGS. 1-2 and showing a support extending through the reservoir cover and having a top end centrally under the bottom surface of the gardening container and in contact with it, a soil-blocking shield over the inclined main channel of the gardening container used for movement of surplus nutrient/fluid to gardening container's drain/outlet opening, thermal insulators secured to the bottom of the reservoir, stand-off features near the top of the gardening container allowing easy release of gardening containers from one another when in stacked array, one arrow indicating the direction of nutrient/fluid flow into a gardening container through a nutrient/fluid line connection with a nutrient/fluid inlet opening on one end of the gardening container, and a second arrow indicating downward flow of nutrient/fluid through the drain/outlet opening in the bottom surface of the gardening container back into the nutrient/fluid supply reservoir for recycling.

FIG. 4 is an exploded view of the invention in FIGS. 1-3 and showing the solar power generating unit and its support separated from the reservoir cover, the two gardening containers also removed from the reservoir cover, the soil-blocking shield removed from each gardening container, the nutrient/fluid line remaining associated with the reservoir cover, the two gardening container supports disassociated from the reservoir cover, the two grommets associated with the tops of the gardening container supports remaining in their positions of use adjacent to the reservoir cover, the reservoir cover separated from the reservoir, and the pump/filter housing removed from the reservoir.

FIG. 5 is a top view of the reservoir cover in FIGS. 1-4 and showing a maintenance access opening centrally therein that provides quick access to pump and filtering apparatus positioned within the reservoir, a two-part positioning support on each side of the maintenance access opening for locked arrangement of a gardening container, all four positioning supports having outlying strengthening gussets and two of them having an arrow pointing toward the nutrient/fluid opening in the reservoir cover that facilitates gardening container installation, a pipe with a float positioned near the maintenance access opening, strengthening ribs adjacent to the maintenance access opening removable plate that add flexural strength to the reservoir cover for support of the gardening containers and the soil they contain, two spiral stars having a central opening for extension of a gardening container support through the reservoir cover that also add strength to the reservoir cover and may provide a sink feature to allow rainwater flow into the reservoir, and a mount between the positioning supports for securing the lower portion of a support for a solar power generating unit

FIG. 6 is a top view of the nutrient/fluid reservoir in FIGS. 1-4 without a cover and showing its walls having strength-enhancing structure, a central positioning guide for a pump/filter unit, a mount for securing the lower end of a support for solar power generating unit, a knock-out in the reservoir wall on one end and on one side for optional easy connection of a nutrient/fluid return line when gardening containers are supported by a frame instead of a reservoir cover, multiple attachment points in the reservoir's bottom surface for connection of an exterior thermal isolator or internal supports, and strength-enhancing ribs between attachment points.

FIG. 7 is a perspective view from the top of the reservoir in FIGS. 1-4 and 6 showing a pump/filter unit secured to the central positioning guide, the cover of the pump/filter unit removed therefrom and positioned outside the reservoir walls so as not to obscure other reservoir structure, nutrient/fluid inlet lines for connection to the nutrient/fluid inlet openings of a gardening container in fluid communication with one end of the pump/filter unit, a mount for securing the lower end of a support for solar power generating unit positioned near the pump/filter unit, multiple attachment points in the reservoir's bottom surface with two gardening container tubular supports and a tube with a float secured thereto, strength-enhancing ribs between attachment points, and the grommet associated with the top end of each tubular support during present invention use removed and positioned outside the reservoir walls for enhanced clarity of illustration.

FIG. 8 is a top view of the pump/filter unit in FIG. 4 and showing its three chambers, three perforated walls, an end wall with an opening used for connection of a nutrient/fluid inlet line to the pump, and two side walls, the far side wall of the pump/filter unit having a mounting hole for support of a vibration-isolating connector that assists in securing the pump/filter unit to the positioning support formed in the bottom surface of the reservoir, a pump and filter material situated in the pump/filter unit, and the pump also having a top fitting used for electrical connection of the pump to the solar power generating unit or an on-board battery.

FIG. 9 is a perspective view from the side of the soil-blocking shield shown in FIG. 2 and having an elongated configuration and raised ends each having similar indentation/deflector structure.

FIG. 10 is a perspective view from the bottom of the soil-blocking shield shown in FIG. 9.

FIG. 11 is a perspective view from the top of a second preferred embodiment of soil-blocking shield usable as a part of the present invention and showing an inlet end with structure similar to that shown in FIG. 9, and its second indentation/deflector structure r having a more elongated configuration and positioning farther away from its drain/outlet end than is shown in FIG. 9 for the first preferred embodiment of soil-blocking shield.

FIG. 12 is a perspective view from the bottom of the soil-blocking shield in FIG. 11.

FIG. 13 is a perspective view from the side of a third preferred embodiment of soil-blocking shield in the present invention and showing top openings for insertion of a tomato stake and other supports for plants, such as but not limited to a portion of a lattice providing vertical support for peas and other climbing plants.

FIG. 14 is a top view of the gardening container in FIGS. 1-4 a soil-blocking shield and showing strength-enhancing structure in side walls, stand-off features in the upper portion of the side walls that allow easy release of stacked gardening containers, a nutrient/fluid inlet opening and an adjacent inlet basin, a nutrient/fluid outlet/drain opening and an adjacent outlet basin, an inclined main channel extending between the nutrient/fluid inlet and outlet/drain openings that is used for transport of surplus nutrient/fluid back to the reservoir for recycling, two peripheral channels, a dam at inlet end of the main channel that blocks entry of nutrient/fluid into the main channel until nutrient/fluid fills the inlet basin and flows into the peripheral channels, raised pads adjacent to the peripheral channels that provide pockets to collect nutrient/fluid and help to promote even soil moisture during periods when the pump in the reservoir is inactive, locating features used to secure the gardening container to a reservoir cover, and a soil-blocking ledge engaged by one end of the soil-blocking shield.

FIG. 15 is a top view of the gardening container in FIG. 14 with the soil-blocking shield shown in FIGS. 9 and 10 positioned over its main channel.

FIG. 16 is a top view of the gardening container in FIG. 14 with the soil-blocking shield shown in FIGS. 11 and 12 positioned over its main channel.

FIG. 17 is a perspective view from the drain/outlet end of the gardening container in FIGS. 1-4 and 14, and showing the bottom surface positioning of the nutrient/fluid outlet/drain opening, strength-enhancing structure in side walls that also have contour allowing gardening container support by a frame, and a punch out hole used with a return outlet tube when the gardening container is supported by a frame instead of a reservoir and its cover.

FIG. 18 is a perspective view from the inlet end of the gardening container in FIGS. 1-4, 14, and 17, and showing a nutrient/fluid inlet opening on the inlet end, a nutrient/fluid outlet/drain opening through the bottom surface of the gardening container, the bottom surface also showing preferred positioning of the main and the peripheral channels, as well as preferred positioning for raised pads and the pockets formed adjacent to the pads, strength-enhancing side wall structure, and a reinforced upper edge that can be used for manual lifting of the gardening container.

FIG. 19 is a section view of the drain/outlet end of the gardening container in FIGS. 1-4, 14, and 17-18, and showing the fluid collection pockets between the raised pads in peripheral channels having a substantially horizontally-extending configuration.

FIG. 20 is an enlarged section view of the inlet end of a gardening container that shows an alternative structure possible for raised pad located in peripheral channels of preferred embodiments of the present invention, with raised pads having angled configuration away from the main channel to divert accumulation of nutrient/fluid away from the soil-blocking shield and reduces the opportunity for soil infiltration under it.

FIG. 21 is a section view from the side of a gardening container in FIGS. 1-4, 14, and 17-19 without a soil-blocking shield and having a nutrient/fluid inlet opening on one of its ends, a bottom nutrient/fluid outlet/drain opening near its opposing end, a main channel extending between the inlet and drain/outlet openings and downwardly inclined toward the drain/outlet opening, a surplus fluid dam/spillway at the head of the inclined main channel, an upper ledge in each opposed end of the gardening container and adjacent to the inlet and drain/outlet openings for support of the ends of the soil-blocking shield, and a nutrient/fluid collecting basin near each opposing end of the gardening container adjacent to the inlet and drain/outlet openings.

FIG. 22 is an enlarged section view from the side of the nutrient/fluid inlet end of the gardening container shown in FIG. 21 with a nutrient/fluid collecting basin near the inlet opening, a small reverse slope in the bottom surface of the gardening container under the basin that allows nutrient/fluid to fill the basin, a dam positioned adjacent to the basin in a remote position from the inlet opening, an inclined main channel on the far side of the dam that receives surplus nutrient/fluid entering the gardening container through the inlet opening after the soil in the gardening container is saturated, and an upper ledge above the inlet opening used for support of one end of a soil-blocking shield.

FIG. 23 is an enlarged section view from the side of the nutrient/fluid drain/outlet end of the gardening container shown in FIG. 21 with a nutrient/fluid collecting basin near the bottom drain/outlet opening, the inclined main channel having fluid communication with the basin, and an upper ledge above the inlet opening used for support of one end of a soil-blocking shield.

FIG. 24 is an enlarged section view from the side similar to that shown in FIG. 22 and showing one end of a soil-blocking shield positioned adjacent to the inlet end of the gardening container and engaging the upper ledge above the inlet opening, with more of the soil-blocking shield extending over the dam and the main channel.

FIG. 25 is an enlarged section view from the side similar to that shown in FIG. 23 and showing one end of a soil-blocking shield positioned adjacent to the drain/outlet end of the gardening container and engaging the upper ledge above the drain/outlet opening, with the soil-blocking shield extending over the basin adjacent to the drain/outlet opening and the main channel.

FIG. 26 is a perspective view from the front of a second preferred embodiment of the present invention hybrid container-gardening system showing two gardening containers at differing elevations supported by a reservoir and its cover, strength enhancing features in the reservoir and gardening container walls, an access opening in the reservoir cover between the gardening containers under a removable plate that provides quick access to pump and filtering apparatus positioned within the reservoir, a solar power generating unit upon a support that is secured by mounts in the reservoir and its cover, and a nutrient/fluid transport line connected between the two gardening containers.

FIG. 27 is a perspective view from the rear of the invention in FIG. 26 and showing two gardening containers at differing elevations with a nutrient/fluid transport line connected between them, and the preferred connection of the solar power generating unit to its support.

FIG. 28 is a nutrient/fluid inlet end view of the gardening container in FIGS. 26-27 and showing its end nutrient/fluid inlet opening and the bottom sculpted indentations on opposing sides of the gardening container that allows support thereof by high and low elevation positioning supports on a reservoir cover.

FIG. 29 is a nutrient/fluid drain/outlet end view of the gardening container in FIGS. 26-27 and showing its end nutrient/fluid drain/outlet opening and the bottom sculpted indentations on opposing sides of the gardening container that allows support thereof by high and low elevation positioning supports on a reservoir cover.

FIG. 30 is a top view of a gardening container in FIGS. 26-29 and showing its drain/outlet opening and adjacent outlet basin used to collect excess nutrient/fluid prior to its exit through outlet/drain opening, its nutrient/fluid inlet opening and adjacent inlet basin where nutrient/fluid collects prior to diversion into peripheral channels, the nutrient/fluid access path providing fluid communication between the inlet basin and the peripheral channels, the primary dam at the inlet end of the main channel that allows nutrient/fluid collection in the inlet basin for upward movement into soil positioned over peripheral channels and the soil-blocking shield superimposed over the main channel, and allowing nutrient fluid flow into the main channel only when the soil around plant roots has become saturated, the bottom locating feature that engages a locking tab on a reservoir cover to provide secure fluid communication between its nutrient/fluid outlet/drain opening and the nutrient/fluid inlet opening in a reservoir cover, the stand-off features on opposing sides of gardening container walls that aid manufacture and also allow easy release of stacked gardening containers from one another, and the spaced-apart raised pads spaced along the gardening container length to provide nutrient/fluid pockets in between them that promote even soil moisture during periods when the reservoir pump is inactive.

FIG. 31 is a front view of a third preferred embodiment of present invention hybrid container-gardening system having two gardening containers with soil-blocking shields at differing elevations for gravity-assisted flow between them, with one broken arrow showing nutrient/fluid flow from the raised fluid transport opening in the reservoir cover to the inlet opening on the gardening container (on the right) having the higher elevation and a second broken arrow showing nutrient/fluid flow from the lower gardening container (on the left) to the raised fluid transport opening in the reservoir cover for reentry of nutrient/fluid back into the reservoir for reuse, a removable plate with a handle on the reservoir cover for expedited access to the filter box and pump located in the reservoir, and the gravity-assisted flow within each gardening container created by the elevation positioning supports on reservoir cover beneath it having slightly differing height dimensions that encourage nutrient/fluid flow toward the drain/outlet opening.

FIG. 32 is a perspective view from the top of the reservoir and reservoir cover in FIG. 31 showing elevation positioning supports on reservoir cover and the height dimensions of the elevation positioning supports intended for support of the same gardening container being slightly different to encourage gravity-assisted nutrient/fluid flow toward the gardening container's drain/outlet, the strength-enhancing extensions on the higher elevation positioning supports, a raised fluid transport opening in the reservoir cover transport of nutrient/fluid from and to the reservoir, reinforced openings through the reservoir cover through which the top portion of an optional tubular support may extend to make contact with the bottom surface of a gardening container, strength-enhancing ribs on the reservoir cover between elevation positioning supports, and a removable plate with a handle aligned with a positioning guide on the reservoir cover for easy access to the filter box and pump located in the reservoir.

FIG. 33 is a perspective view from the top of a fourth preferred embodiment of the present invention hybrid container-gardening system having three gardening containers at substantially the same elevation supported by a reservoir and its cover.

FIG. 34 is a bottom view of the reservoir in FIG. 33 and showing its preferred strength-enhancing features.

FIG. 35 is a perspective view from the top of the reservoir cover in FIG. 33 that shows its preferred strength-enhancing ribs, elevation positioning supports for gardening containers each having substantially the same height dimension, and a maintenance access opening.

FIG. 36 is a perspective view from the bottom of the gardening container in FIG. 33 that shows the preferred positioning of the nutrient/fluid inlet opening and opposed nutrient/fluid drain/outlet opening, the main channel extending between the inlet and outlet openings that is used for travel of surplus nutrient/fluid to drain/outlet opening after soil positioned within the gardening container becomes saturated with nutrient/fluid, the two peripheral channels that provide an interface for soil and nutrient/fluid and from which nutrient/fluid moves into the soil for plant root uptake, the access path through which some nutrient/fluid entering the gardening container through its inlet opening moves into one of the peripheral channels, a primary dam which slows travel of nutrient/fluid into the main channel and instead allows some of it to collect near the inlet opening for movement into the peripheral channels, a small nutrient/fluid diverting obstruction positioned between the dam and the drain outlet opening that slows nutrient/fluid flow through the main channel also provides oxygenation of nutrient/fluid, and a reinforced curved upper edge that can be used as a handle for easy manual lifting of the gardening container.

FIG. 37 is top view of the gardening container in FIGS. 35-36 that shows the main channel, extending between the nutrient/fluid inlet opening and nutrient/fluid drain/outlet opening, the two peripheral channels that provide an interface for soil and nutrient/fluid, the downwardly-inclined ramps adjacent to the inlet and drain/outlet openings that promote accumulation of nutrient/fluid for diversion into peripheral channels, the access path through which some nutrient/fluid entering the gardening container through its inlet opening moves into a peripheral channel, a primary dam which slows travel of nutrient/fluid into the main channel and instead allows some of it to collect near the inlet opening for movement into the peripheral channels, a small nutrient/fluid diverting obstruction positioned between the dam and the drain/outlet opening that slows nutrient/fluid flow through the main channel and also provides oxygenation of nutrient/fluid, a reinforced curved upper edge that can be used as a handle for easy manual lifting of the gardening container, and the ledges above the inlet and drain/outlet openings that assist in sealing the contact area between the gardening container wall and one end of the soil-blocking shield to prevent soil infiltration, into the main channel.

FIG. 38 is section view from the side of the gardening container in FIGS. 35-37 that shows the main channel extending between the nutrient/fluid inlet opening and nutrient/fluid drain/outlet opening, the downwardly-inclined ramps adjacent to the inlet and drain/outlet openings, the primary dam, the small nutrient/fluid diverting obstruction positioned between the dam and the drain/outlet opening, and the ledges above the inlet and drain/outlet openings that help seal an end of the soil-blocking shield to prevent soil infiltration into the main channel.

FIG. 39 is an enlarged section view from the side of the drain/outlet end of the gardening container in FIGS. 35-38 that shows the drain/outlet opening in fluid communication with the main channel, a small downwardly-inclined ramp adjacent to the drain/outlet opening, and the ledge above the drain/outlet opening that helps to seal the drain/outlet end of the soil-blocking shield against the adjacent end wall of the gardening container to prevent soil infiltration into the main channel.

FIG. 40 is an enlarged section view from the side of the inlet end of the gardening container in FIGS. 35-39 that shows the inlet opening in fluid communication with the main channel, a large downwardly-inclined ramp adjacent to the inlet opening, the primary dam, the small nutrient/fluid diverting obstruction positioned between the dam and the drain/outlet opening, and the ledge above the inlet opening that helps to seal the inlet end of the soil-blocking shield against the adjacent end wall of the gardening container to prevent soil infiltration into the main channel.

FIG. 41 is a perspective view from the side of three gardening containers in a fifth preferred embodiment of the present invention hybrid container-gardening system supported by a frame in stepped configuration that permits gravity flow of nutrient/fluid from the gardening container having the highest elevation and in succession to the gardening container having the next highest elevation, with two reservoirs positioned under the gardening containers.

FIG. 42 is a perspective view from the bottom of the reservoir in FIG. 41 that shows the strength-enhancing structure of reservoir walls, lid supports in the end wall of the reservoir that may also include a safety-enhancing locking feature to secure the reservoir cover in place and prevent reservoir access to reservoir contents by pets or children, an alignment guide integrated into the reservoir's bottom surface and used to obtain secure positioning for a pump/filter unit, four attachment points in the reservoir's bottom surface used for securing the lower ends of gardening container supports, and strength-enhancing ribs integrated into the reservoir's bottom surface.

FIG. 43 is a perspective view from the top of the reservoir in FIGS. 41-42 and further showing all four of the lid supports, a pump/filter unit secured in place by the alignment guide strengthened wall structure, a pump/filter unit, strengthening ribs in the gardening container's bottom surface, and four vertically-extending tubular gardening container supports each having a lower end secured by a different one of the attachment points.

FIG. 44 is a perspective view from the top of the reservoir in FIGS. 41-43 and further showing the preferred height dimension of each of the four attachment points for the gardening container supports, and a knock-out near the bottom surface of the reservoir used for connection of a nutrient/fluid line.

FIG. 45 is a side view of three gardening containers in a sixth preferred embodiment of the present invention hybrid container-gardening system supported by a frame in stepped configuration that permits gravity flow of nutrient/fluid from the gardening container having the highest elevation and in succession to the gardening container having the next highest elevation, one large reservoir positioned under the gardening containers, a reservoir cover configured for placement/support of two additional gardening containers, a nutrient/fluid inlet line connected between the reservoir and the gardening container having the highest elevation, additional nutrient/fluid inlet transport lines connected between adjacent gardening containers, a nutrient/fluid return line connected between the gardening container having the lowest elevation and the reservoir cover, rubber feet or other thermal insulator secured to and supporting the reservoir's bottom surface, and a solar power unit connected by a support to the frame.

FIG. 46 is a perspective view from the side of four gardening containers in a seventh preferred embodiment of the present invention hybrid container-gardening system supported by a modular frame in stepped configuration that permits gravity flow of nutrient/fluid from the gardening container having the highest elevation and in succession to the gardening container having the next highest elevation, with additional modular frame units easily connected to the modular frame supporting the gardening containers with the lowest elevations.

FIG. 47 is a perspective view of a gardening container in FIG. 46 that shows opposed nutrient/fluid inlet and outlet openings, strength-enhancing wall structure, three stand-off features on each top edge of the gardening container's opposed side walls that allow easy release of adjacent stacked gardening containers, an exterior indentation on the upper portion of one end of the gardening container that serves as one of two opposed hand-holds used for gardening container manipulation, an access path through which some nutrient/fluid entering the gardening container through its inlet opening moves into a peripheral channel, and the raised pads and pockets within a peripheral channel that provide an interface for soil and nutrient/fluid so that the soil containing plant roots can upwardly draw nutrient/fluid for uptake by the plant roots.

FIG. 48 is a top view of the gardening container shown in FIGS. 46-47 that further shows one hand-hold on the upper portion of each end of the gardening container, the main channel extending between the nutrient/fluid inlet opening and nutrient/fluid drain/outlet opening, one peripheral channel adjacent to each side of the main channel, the access path through which some nutrient/fluid entering the gardening container through its inlet opening moves into a peripheral channel, a primary dam which slows travel of nutrient/fluid into the main channel and instead allows some of it to collect near the inlet opening for movement into the peripheral channels, a small nutrient/fluid diverting obstruction positioned between the dam and the drain/outlet opening that slows nutrient/fluid flow through the main channel and also provides oxygenation of nutrient/fluid, and the ledges above the inlet and drain/outlet openings that assist in sealing the contact area between the gardening container wall and one end of the soil-blocking shield to prevent soil infiltration into the main channel.

FIG. 49 is a top view of the gardening container or planter.

FIG. 50 is a cross-sectional side view of the gardening container or planter with soil and plants taken along line 50-50 of FIG. 49.

FIG. 51 is a cross-sectional end view of the gardening container or planter taken along line 51-51 of FIG. 49.

FIG. 52 is a cross-sectional end view of the gardening container or planter taken along line 52-52 of FIG. 49.

FIG. 53 is a top view of the soil support cover.

FIG. 54 is a side view of the soil cover.

FIG. 55 is an end view of the soil cover.

FIG. 56 is an end view of the soil cover from the end opposite shown in FIG. 55.

Similar reference characters refer to similar parts throughout the several views of the drawings.

### DETAILED DESCRIPTION OF PREFERRED EMBODIMENTS

This invention relates to gardening containers (2A-2E, and other) used for cultivating plants (not shown) in a water-conserving hybrid container-gardening system that can be used indoors or outdoors for growing food-producing and ornamental plants. Although not shown, when indoor is contemplated, a plant growth facilitating ultra-violet light may be used with the present invention. The system combines the advantages and benefits of natural bacteria-enriched soil (not shown) with the advantages and benefits of hydroponics to feed plant roots oxygenated nutrient/fluid precisely at the time of need for optimal root/plant growth. Present invention structure includes the combination of reservoir (3A-3D, or other), pump 40, fluid transport line (8A-8C), and one or more gardening containers (2A-2E, or other) each having water-elevating structure that causes a slow and consistent flow of oxygenated nutrient/fluid in an upwardly direction through soil to plant roots until soil saturation occurs, after which drainage-facilitating structure in the areas of soil-fluid interface and elsewhere in each present invention gardening container diverts surplus nutrient/fluid (newly incoming nutrient/fluid and that already present in the gardening container which is not immediately needed for plant growth) away from plant roots to prevent the plant stunting and disease-promoting impact that stagnant nutrient/fluid could otherwise have on plant roots after the pump stops. Furthermore, to prevent soil infiltration and blockage of fluid flow within the present invention system, including blockage of the nutrient/fluid transport lines (8B) connected between adjacent gardening containers, each present invention gardening container (2A-2E, or other) also has at least one peripheral channel (50A or 50B) providing a soil-fluid interface for uptake of nutrient/fluid by plant roots, while the remaining fluid-flow-assisting structure therein (including a main channel 20) has shielded protection (using 14A-14C, or other) against soil infiltration during its use for management of surplus nutrient/fluid entering the gardening containers (2A2E, or other) after fluid saturation of soil in the peripheral channel or channels (50A or 50B) occurs. Gardening containers (2A-2E, or other) in preferred embodiments of the present invention hybrid system may be connected to one another in multiple stepped gravity-feed arrangements, have non-stepped arrangement relative to others having the same or similar support, be supported with or without stepped gravity-feed arrangement or connection to one another upon a strength-enhanced and sturdy reservoir (3A-3D or other) and its cover (4A-4E, or other), be supported by a modular frame (76A and 76B) that permits simple and easy system expansion to include the temporary or permanent addition of more gardening containers (2A-2E, or other) when needed, be supported by an elevated frame (73 or 76A and 76B) with or without sufficient height to provide underneath storage for one or more nutrient/fluid supply reservoirs (3A-3D or other), or a combination thereof in a variety of arrangements. Advantages of the present invention include compact and portable configurations suited for porch/balcony/patio use, larger configurations usable for more diverse residential food and herb production than the compact configurations, controlled/moderated root temperature during root/plant growth that helps to extend growing seasons even as seasonal increases or decreases in temperature occur, reservoir cover structure allowing rainwater replenishment of a nutrient/fluid supply reservoir (3A-3D or other), supporting one or more gardening containers (2A-2E, or other), and use of inexpensive soils, nutrients, and filtration media that are commonly-available from local suppliers instead of requiring operators to purchase special-order/dedicated supplies and filtration media.

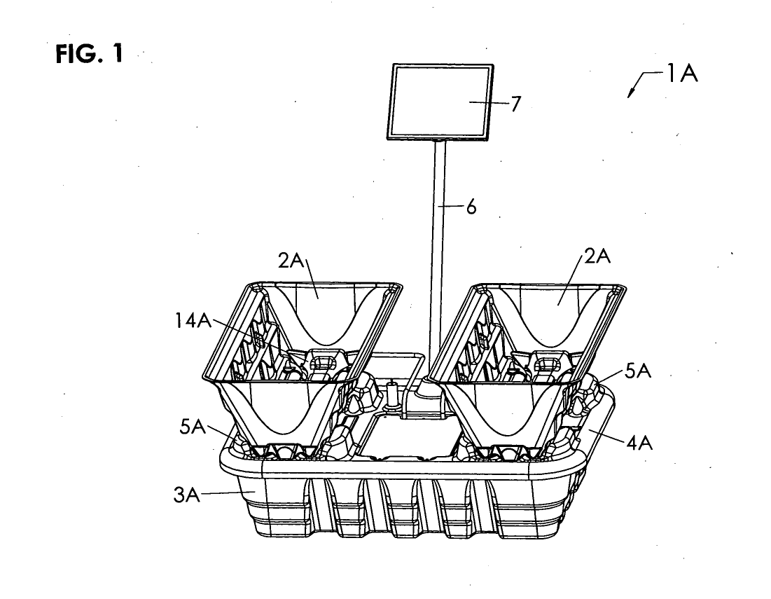

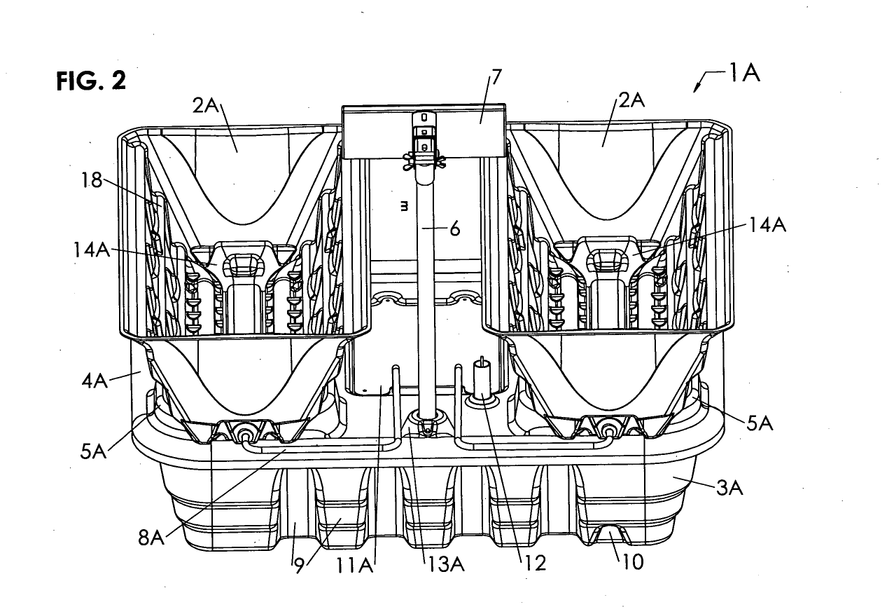

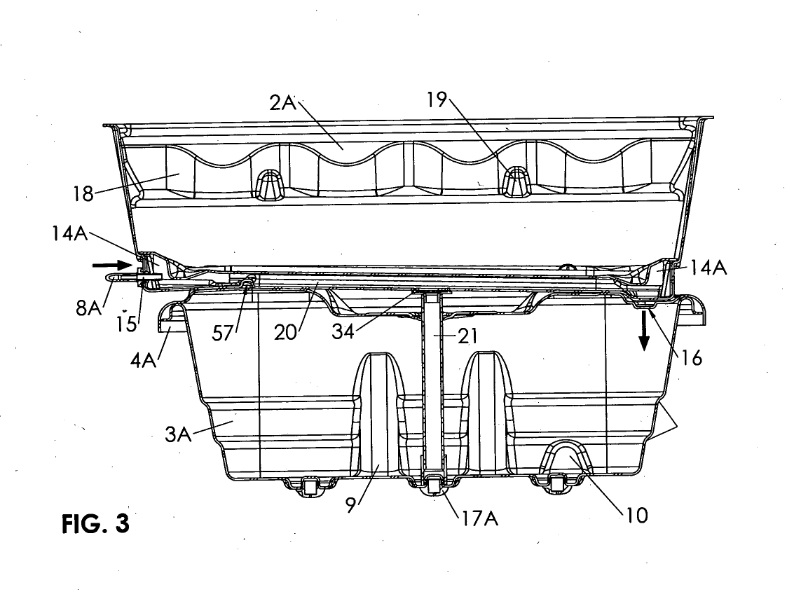

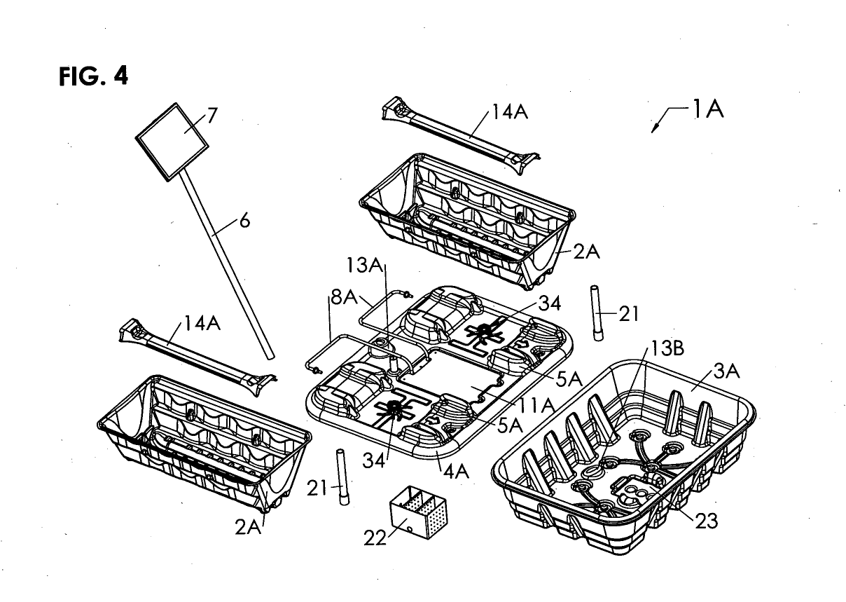

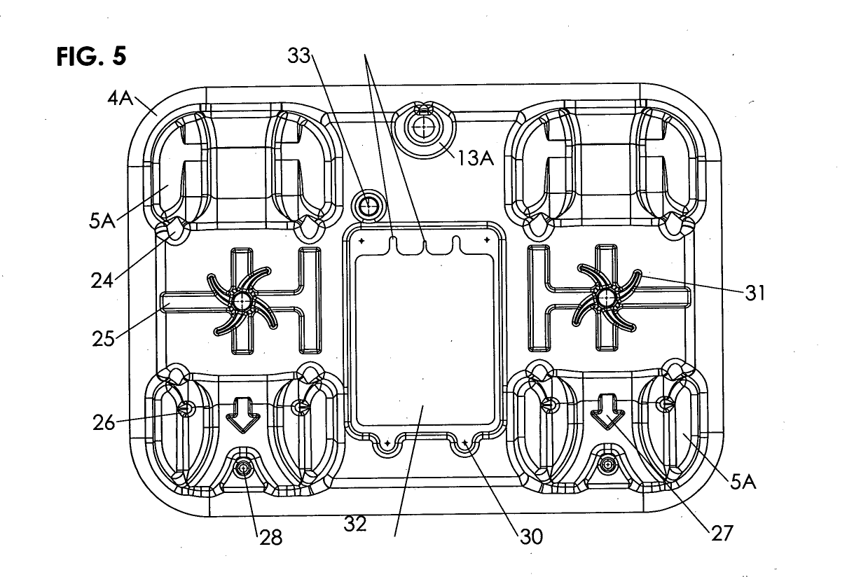

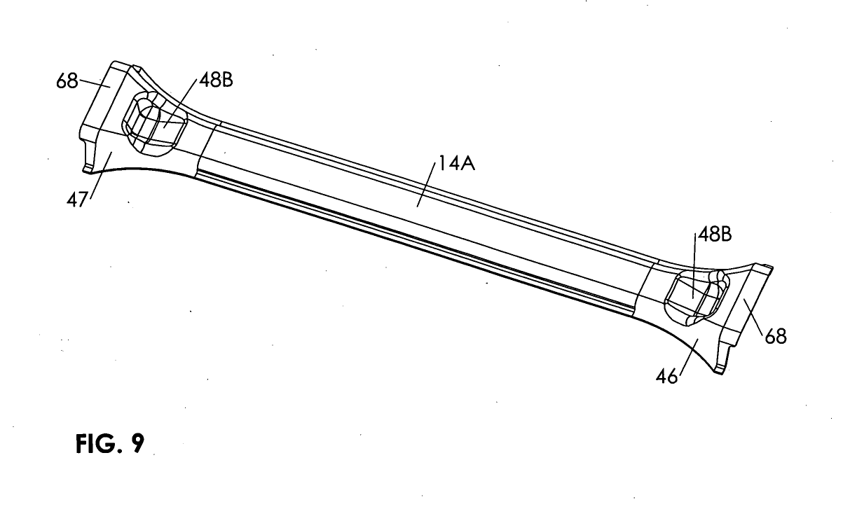

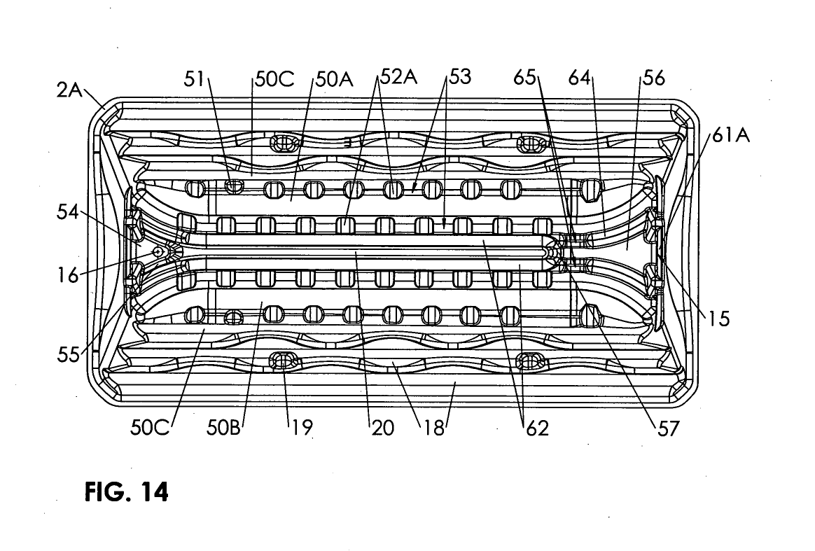

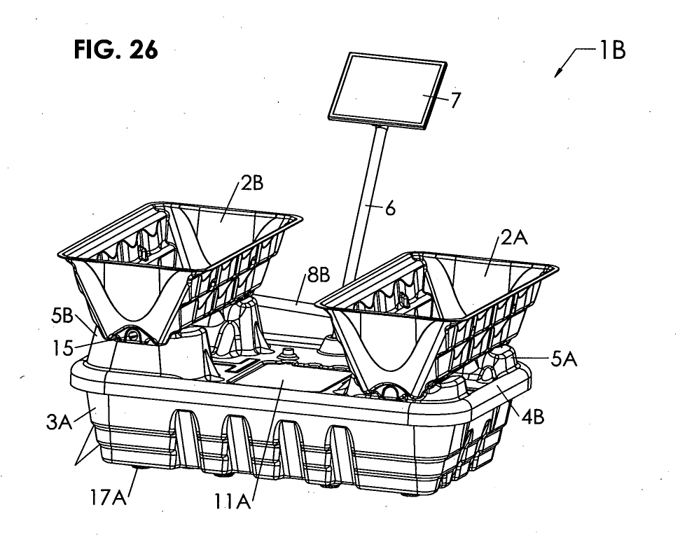

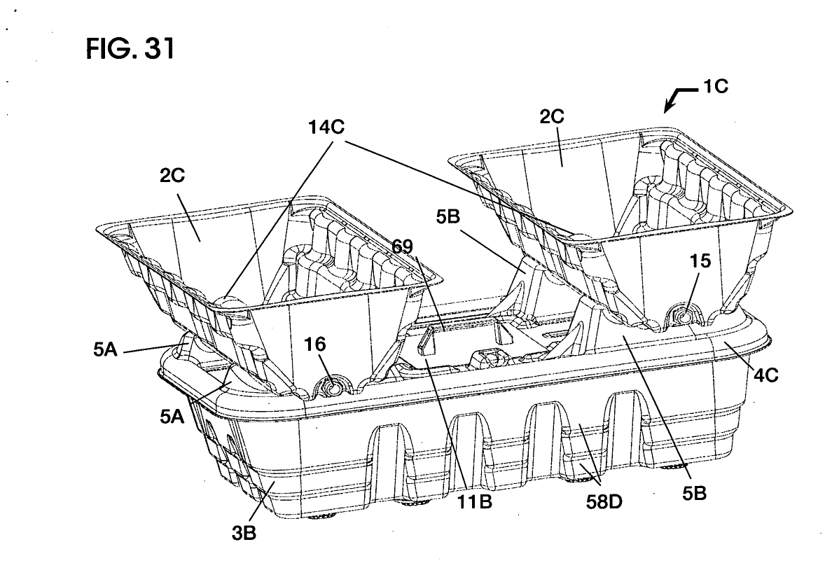

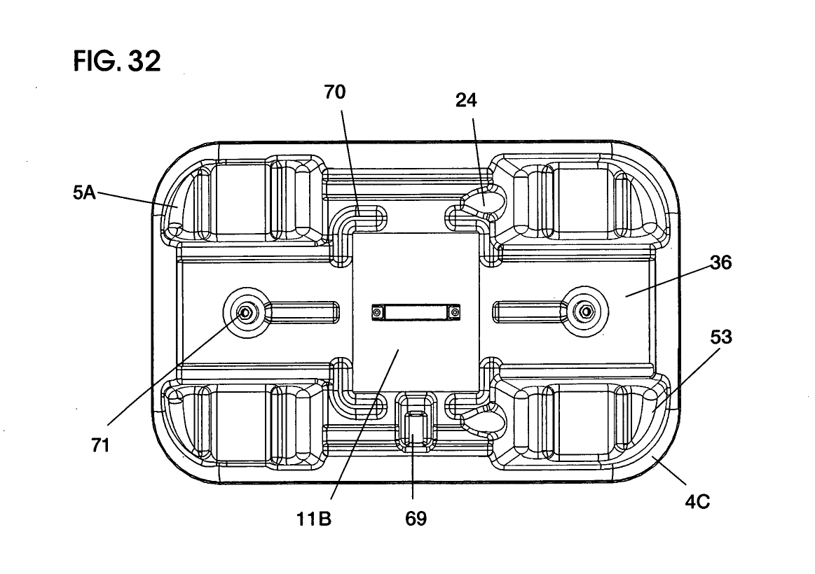

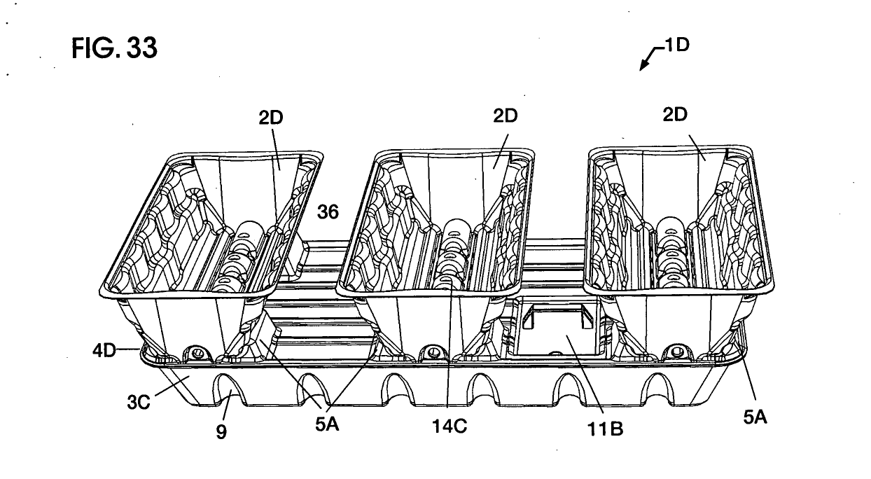

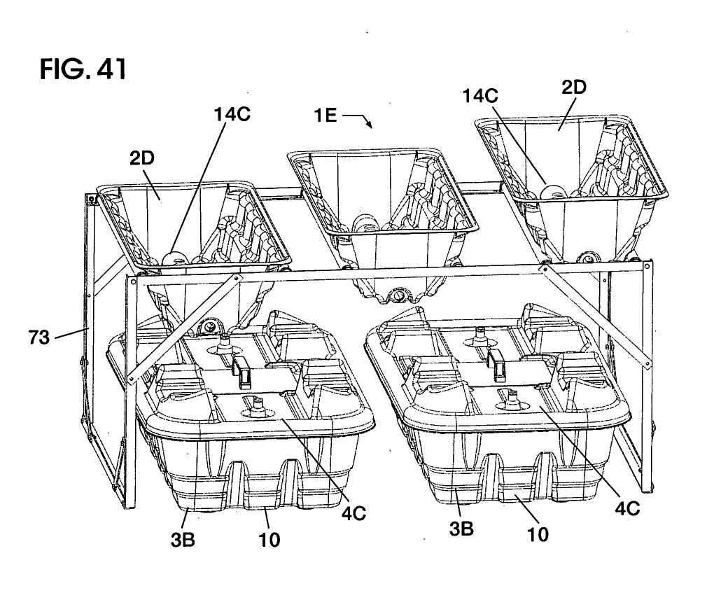

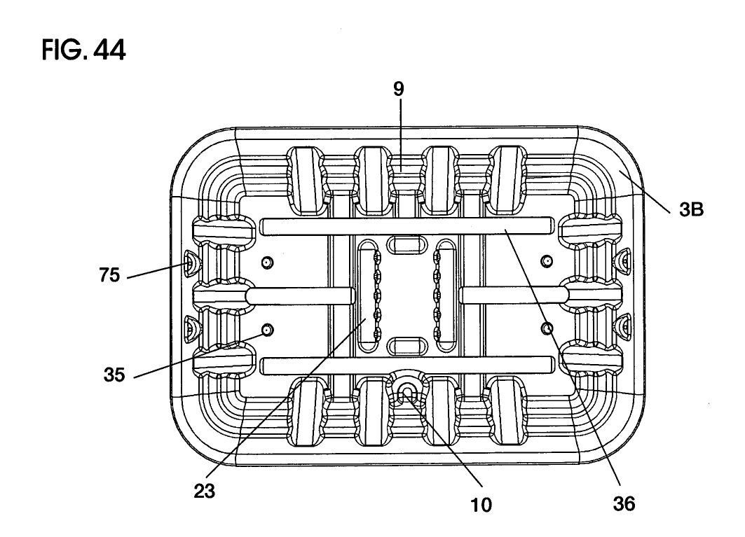

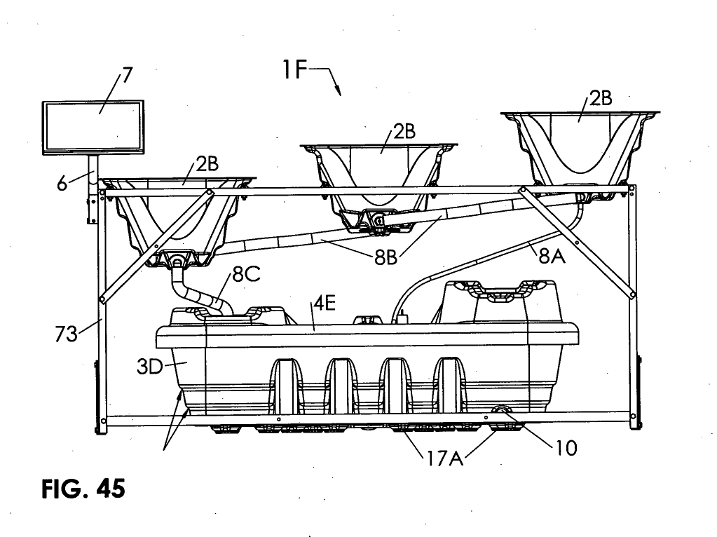

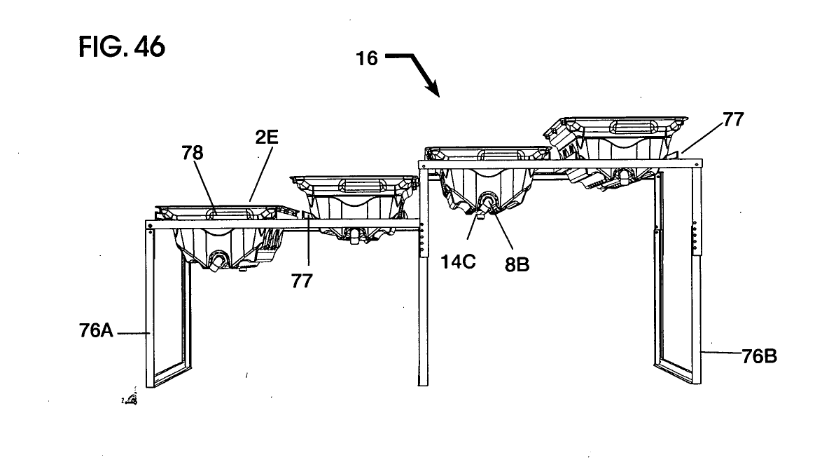

FIGS. 1-25 show a first preferred embodiment 1A of the present invention hybrid container-gardening system. FIGS. 1 and 2 show preferred embodiment 1A in an assembled condition, while FIG. 3 shows a section view thereof and FIG. 4 shows and exploded view. FIGS. 5-8 show views of the reservoir 3A and its cover 4A, while FIGS. 9-13 show the structure of three soil-blocking shields 14A, 14B and 14C. In addition, FIGS. 14-25 illustrate the preferred structure of the gardening container 2A in the first preferred embodiment 1A of the present invention in varying views, including section views that show nutrient/fluid management structure. In contrast, FIGS. 26-48 disclose six additional preferred embodiments 1B-1G of the present invention, which comprise varying combinations of gardening container (2A-2E), reservoir (3A-3D), and frame (73, 76) construction, with all having a gardening container (2A-2E) that includes channel (20, 50A, 50B, 50C), basin (54, 56), and soil-blocking structure (14A, 14B, 14C) for nutrient/fluid diversion into peripheral channels (50A, 50B) that provide a nutrient/fluid and soil interface for upward movement of sufficient nutrient/fluid into the soil supporting plant roots to allow the soil to become saturated, structure that adds oxygen to nutrient/fluid recycled within the system, additional structure that prevents upward movement of excess nutrient/fluid into soil supporting plant roots, and further drainage-facilitating structure causing the exit of surplus nutrient/fluid from the gardening container (2A-2E, or other) to prevent fluid stagnation and the negative impact thereof on root/plant growth. FIGS. 26-30 show a second preferred embodiment 1B that has gardening containers 2A and 2B at differing elevations supported upon a reservoir 3A and reservoir cover 4A, with one gardening container 2A discharging surplus nutrient/fluid into reservoir 3A directly through an opening in reservoir cover 4A. In contrast, FIGS. 31 and 32 show a third preferred embodiment 1C of the present invention with gardening containers 2C at differing elevations and other structure visibly similar to that shown in FIGS. 26-30. However, the flow of nutrient/fluid in third preferred embodiment 1C is different from that in the second preferred embodiment 1B, as the nutrient/fluid return line in third preferred embodiment 1C is connected to a raised fluid transport opening 69 in reservoir cover 4C used as an exit port for nutrient/fluid transport from pump 40 to the inlet opening 15 in the gardening container 2C having the highest elevation (on the right in FIG. 31). Raised fluid transport opening 69 is also used as a return port for surplus nutrient/fluid flowing back to reservoir 3B from the gardening container 2C having the lowest elevation (on the left in FIG. 31). FIGS. 33-40 show a fourth preferred embodiment 1D of the present invention having three growing containers 2D supported at the same elevation by a large reservoir 3C and its reservoir cover 4D. FIGS. 41-44 show a fifth preferred embodiment 1E of the present invention having three gardening containers 2D supported at differing elevations by a frame 73 above two reservoirs 3B positioned in a space-saving configuration under frame 73. FIG. 45 shows a sixth preferred embodiment 1F of the present invention having three gardening containers 2B supported at differing elevations by a frame 73 similar to that shown in FIG. 44, which are positioned above one large reservoir 3C housed under frame 73, with a solar power generating unit attached to frame 73 and preferred connection of nutrient/fluid lines 8A-8C also visible. FIGS. 46-48 show a seventh preferred embodiment 1G of the present invention having four gardening containers 2E supported at differing elevations by a modular frames 76A and 76B in a stepped configuration that permits gravity flow of nutrient/fluid from the gardening container 2E having the highest elevation and in succession to the gardening container 2E having the next highest elevation. Nutrient/fluid entering gardening containers (2A-2E, or other) through inlet opening 15 may be moving slow or fast, with the incline/slope of gardening containers (2A-2E, or other) controlling the movement of nutrient/fluid through them. However, nutrient/fluid entering soil-fluid interface areas provided by raised pads 52A and pockets 53 in peripheral channels 50A and 50B is slowed by soil contact, and then progressively and consistently moves upward into soil for uptake by plant roots supported in the soil. A second row of raised pads 52A and pockets 53 more distant from main channel 20 can be associated with a peripheral channel 50C that is situated at a higher elevation in gardening container 2A than peripheral channels 50A and 50B. The incline/slope may be integral to gardening containers (2A-2E, or other), or provided in part or totally by supporting reservoirs 3A-3D or frames (73, 76, or other).

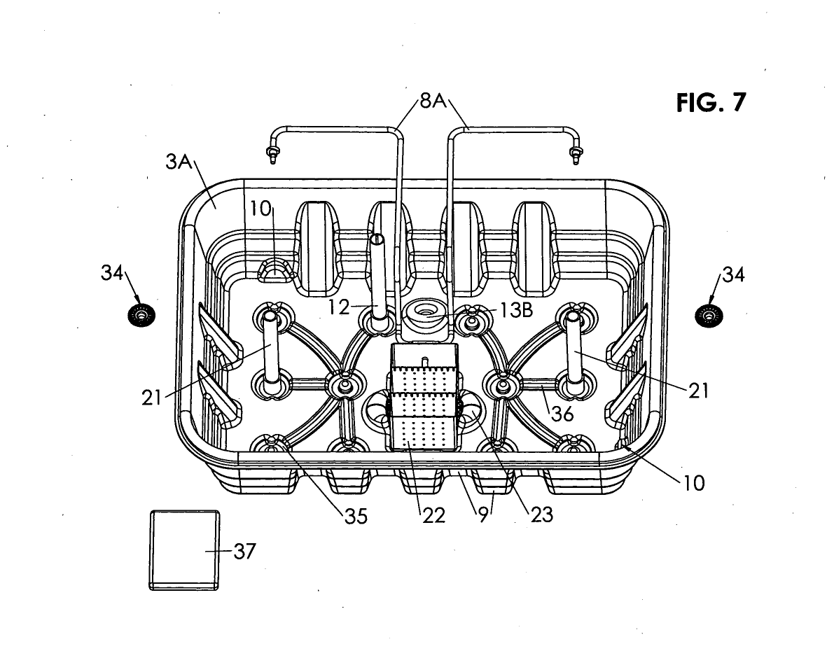

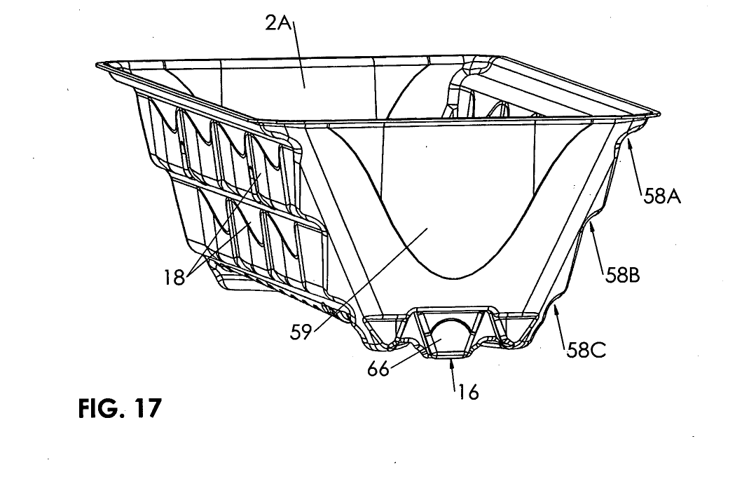

FIGS. 1-25 show a first preferred embodiment 1A of the present invention container-gardening system that is small and compact in configuration, making it convenient for use on a small porch, balcony, or small patio area. Although not limited thereto, its reservoir 3A could have a nutrient/fluid capacity of approximately 25-gallons. FIGS. 1 and 2 show preferred embodiment 1A in an assembled condition, while FIGS. 3 and 4 respectively show section and exploded views thereof. FIG. 1 is a perspective view from the front of first preferred embodiment 1A showing two gardening containers 2A at the same elevation supported upon the removable cover 4A of a nutrient/fluid reservoir 3A. Although two gardening containers 2A are shown, more than two could be used (see three gardening containers 2D supported by a reservoir 3C in FIG. 33). Each gardening container 2A in first preferred embodiment 1A has independent fluid communication with reservoir 4A, but no fluid communication with one another, obtaining nutrient/fluid from reservoir 3A via nutrient/fluid inlet line 8A and returning surplus nutrient/fluid not needed by plants growing in soil (not shown) therein to reservoir 3A via a direct fluid alignment/connection between nutrient/fluid drain/outlet opening 16 and the nutrient/fluid inlet opening 28 in reservoir cover 4A. The two nutrient/fluid inlet openings 28 (see FIG. 5) in reservoir cover 4A are each positioned under the bottom drain/outlet opening 16 in a different one of the two gardening containers 2A present, and remain hidden from view when gardening containers 2A are in their positions of use, as shown in FIGS. 1 and 2. FIGS. 1 and 2 also both show a soil-blocking shield 14A positioned centrally and longitudinally within each gardening container 2A, preferably in contact with its opposed end walls, as well as the elevation positioning supports 5A integral to reservoir cover 4A and upon which each gardening container 2A is secured using a connection between the locking features 51 on the gardening containers 2A and the locking tabs 26 (see FIG. 5) integral to the elevation positioning supports 5A. In addition, the bottom sculpted indentations 58C (see FIG. 17) on the opposing sides of each gardening container 2A engage complementary structure found on elevation positioning supports 5A to constrain gardening containers 2A from movement relative to reservoir cover 4A and reservoir 3A during their plant cultivation use. FIGS. 1 and 2 further show first preferred embodiment 1A having a solar power generating unit 7 mounted upon an elongated support 6 having its lower end secured by mounts 13B and 13A respectively to reservoir 3A and its cover 4A. While the use of solar energy for operation of pump 40 is preferred, it is not critical. Although not shown, more than one solar power generating unit 7 and/or support 6 is also considered to be within the scope of the present invention, and the configuration and position of the solar power generating unit or units 7 in the present invention are not limited to that illustrated in FIGS. 1 and 2. Furthermore, although not shown, a timer could be associated with support 6 and/or solar power generating unit or units 7. FIG. 2 is a perspective view from the rear of first preferred embodiment 1A and shows one connection possible between support 6 and solar power generating unit 7 and a fastened connection between support 6 and the mount 13A in reservoir cover 4A into which it is inserted. FIG. 2 also shows two parts of a nutrient/fluid line 8A extending between reservoir 3A and the inlet opening 15 of each gardening container 2A (also see FIG. 7), strength-enhancing features 9 and 18 respectively in the walls of reservoir 3A and gardening containers 2A, and a removable plate 11A (optionally locking to prevent reservoir access by pets and children) positioned over a maintenance access opening 29 in reservoir cover 4A that is positioned between gardening containers 2A and provides quick access to pump 40 and filtering apparatus (39, 45, other) positioned within reservoir 3A. In addition, FIG. 2 shows a knock-out 10 in the lower wall of reservoir 3A that can be used for connection of nutrient/fluid return line 8C if reservoir 3A was later employed in another embodiment of the present invention requiring different nutrient/fluid line connections (8A-8C), and a vertically-extending tube 12 with a float extending through the reservoir cover 4A that provides a visible indicator of the amount of nutrient/fluid remaining in reservoir 2A.

FIG. 3 is a section view from the side of one gardening container 2A positioned atop reservoir cover 4A in the first preferred embodiment 1A of the present invention (with solar power generating unit 7 and support 6 omitted); and one arrow next to the word “IN” showing the inward flow of nutrient/fluid into one end of gardening container 2A from a nutrient/fluid inlet line 8A and a second arrow next to the word “OUT” near the opposing end of gardening container 2A showing the downward exit of surplus nutrient/fluid from the drain/outlet opening 16 in the bottom of gardening container 2A directly into reservoir 3A. Although the preferred positioning for nutrient/fluid inlet opening 15 and nutrient/fluid drain/outlet opening 16 in preferred embodiment 1A is shown in FIG. 3, it should be noted that other preferred embodiments of the present invention may have other positioning for nutrient/fluid inlet opening 15 and/or nutrient/fluid drain/outlet opening 16. In the first preferred embodiment 1A, a main channel 20 extends between nutrient/fluid inlet opening 15 and nutrient/fluid drain/outlet opening 16, and is downwardly inclined toward drain/outlet opening 16. Inclined main channel 20 is employed to carry surplus nutrient/fluid not needed by plants grown in gardening container 2A to drain/outlet opening 16 so that it can be returned to reservoir 3A for recycling, however, nutrient/fluid only enters main channel 20 after saturation of soil in gardening container 2A occurs. Although in first preferred embodiment 1A main channel 20 is structurally inclined, in other preferred embodiments of the present invention the needed incline for gravity-feed flow of surplus nutrient/fluid may be provided by non-level structure on a supporting reservoir cover (4A or other), via a non-level frame (73, 86, or other), or any combination of thereof in addition to inclined structure integral to the bottom surface of a gardening container (2A or other). The nutrient/fluid inlet opening 28 in cover 4A that is under the drain/outlet opening 16 of gardening container 2A, and in fluid communication with drain/outlet opening 16, is positioned immediately above the letter “T” in the word “OUT”, and is not otherwise marked with a numerical designation for lack of space on the illustration. FIG. 3 also shows a centrally-positioned optional support 21 for the gardening container 2A above it that extends through reservoir cover 4A. Support 21 provides an air gap to reduce heat conduction from reservoir into gardening containers 2A. It also has a grommet 34 on its top end that becomes positioned between the top end of support 21 and the bottom surface of gardening container 2A when gardening container 2A is in its desired position of use. Although not shown, a similar optional support 21 and grommet 34 could be optionally used with the other gardening container 2A employed as a part of first preferred embodiment 1A. While the use of support 21 and a grommet 34 is not considered critical for the support of a gardening container 2A, they might extend the useful life of reservoir cover 4A and reservoir 3A that otherwise would bear the full weight of a gardening container 2A filled with nutrient/fluid saturated soil. In addition, FIG. 3 shows a soil-blocking shield 14A over the main channel 20 that extends longitudinally from one end of gardening container 2A to the other and prevents soil infiltration into main channel 20 while it transports surplus nutrient/fluid toward drain/outlet opening 16 and exit therefrom for recycling after being filtered and otherwise reconditioned in nutrient/fluid supply reservoir 3A. FIG. 3 also shows the stepped indentations 58D in the walls of reservoir 3A that add strength and rigidity to help prevent reservoir 3A from collapsing under the weight of the soil-filled gardening containers it supports (2A-2E, or other). As can be seen in FIG. 3, the topmost stepped indentation 58D has the largest perimeter dimension. FIG. 3 further shows thermal insulators 17A secured to the bottom surface of reservoir 3A that help maintain a more uniform temperature of nutrient/fluid in reservoir 3A, a nutrient/fluid inlet line 8A that may be insulated against temperature fluctuation which is connected to the inlet opening 15 in gardening container 2A, stand-off features 19 near the top edge of gardening container 2A that allow easy release of gardening containers 2A from one another when positioned in stacked array, strength-enhancing structure 9 and 18 respectively integrated into the walls of reservoir 3A and gardening container 2A to assist them in fulfilling their support functions, a knock-out 10 in the lower wall of reservoir 3A that can be used for connection of a nutrient/fluid line 8C if reservoir 3A is adapted for use as a part of other preferred embodiments of the present invention, and a dam 57 in gardening container 2A positioned between nutrient/fluid inlet opening 15 and main channel 20 that permits fluid saturation of soil in gardening container 2A prior to release of surplus nutrient/fluid into main channel 20. Thus, after sufficient nutrient/fluid enters gardening container 2A via inlet opening 15 for irrigating plant with roots secured by soil positioned therein above soil-blocking shield 14A and soil saturation occurs, surplus nutrient/fluid is diverted from entering soil-fluid interface areas (see 50A, 50B and 50C in FIG. 14) where it slowly and consistently moves upwardly into the soil, thereafter spilling over dam 57 and traveling across the inclined main channel 20 to nutrient/fluid outlet/drain opening 16 in the bottom surface of gardening container 2A, with the surplus nutrient/fluid exiting gardening container 2A via drain/outlet opening 16 and returning to reservoir 3A where it may undergo filtration and other treatment prior to being recycled into either of the gardening containers 2A supported by reservoir cover 4A and reservoir 3A.

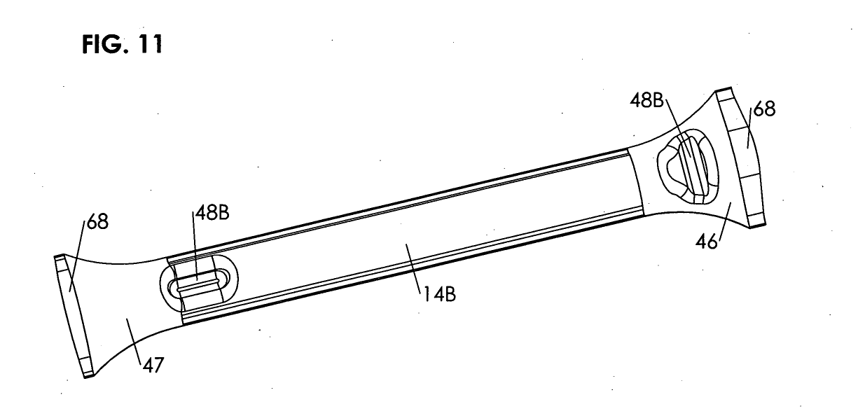

FIG. 4 is an exploded view of the first preferred embodiment 1A of the present invention showing the solar power generating unit 7 and its support 6 separated from reservoir cover 4A. The illustrations of solar power generating unit 7 and support 6 are merely exemplary, and the number, relative size, configuration, and surface texture of solar power generating unit 7 and support 6 are not critical and may differ from that shown in FIG. 4. Also, although not shown, a timer for pump 40 may be associated with solar power generating unit 7 or its support 6. The two gardening containers 2A in first preferred embodiment 1A are also removed from reservoir cover 4A, and the soil-blocking shield 14A in each gardening container 2A is also removed therefrom and set to the side. In addition, FIG. 4 shows the nutrient/fluid inlet line 8A remaining associated with the removable plate 11A in reservoir cover 4A, the two gardening container supports 21 disassociated from reservoir cover 4A (although the grommets 34 positioned between the top of each support 21 and the bottom surface of the gardening container 2A above it remains in their positions of use to mark the location where the two supports 21 for gardening containers 2A are used). Reservoir cover 4A is also separated from reservoir 3A, and the pump/filter housing 22 is shown without its cover (see number 37 in FIG. 7) and is also removed from its preferred positioning in reservoir 3A. The strength-enhancing configurations 9 and 18 respectively integral to the walls of reservoir 3A and gardening containers 2A that are shown in FIG. 4 are merely exemplary and should not be considered as limiting, except that some complementary structure (including sculptured indentations 58A-58C) is needed to allow secure support of gardening containers 2A upon reservoir cover (4A-D or other) or by a frame (73, 76, or other). Also, the addition of water, rainwater, or nutrient/fluid to reservoir 3A can be achieved via use of the spiral star features 31 (see FIG. 5 for an enlarged view thereof) in reservoir cover 4A that are minimally visible in FIG. 4, and FIG. 4 also shows the access plate 11A still in its position of use over maintenance access opening 29 (see FIG. 5) in reservoir cover 4A. Furthermore, FIG. 4 shows the optional vertically-extending tube 12 with a float still extending through reservoir cover 4A which provides a quick visual indication of the amount of nutrient/fluid remaining in reservoir 3A and may be used as a quick-fill tube for adding a small amount of nutrient/fluid to reservoir 3A when the float is removed. FIG. 4 also shows the elevation supports 5A on reservoir cover 4A upon which gardening containers 2A are received, the mount 13A in reservoir cover 4A and the mount 13B that are both used to secure and stabilize the lower end of the support 6 used with solar power generating unit 7, the strengthening structure in the side walls and bottom surface of reservoir 3A, as well as the alignment guide 23 integrated into the bottom surface of reservoir 3A that is employed for securing filter/pump unit 22 into its position of use. Although not clearly shown in FIGS. 1-4, one or more fasteners are typically used to faster support 6 to mounts 13A and 13B. Also, although not shown, a rubber grommet may be connected to the lower end of support 6 to enhance the secure connection needed for solar power generating unit 7. The shape and positioning of the alignment guide 23 is not critical or limited to that shown in FIG. 4, as long as it is able to fix the positioning of filter/pump unit 22 while pump 40 is recycling nutrient/fluid for root/plant growth. In addition, the configuration of the soil-blocking means employed in preferred embodiment 1A is not limited to the soil-blocking shield 14A shown in FIG. 4, or limited to the other soil-blocking shields 14B and 14C respectively shown in FIGS. 11-13, all of which are merely exemplary as means of blocking soil infiltration into main channel 20 and also preferably providing a deflector or other means of creating turbulence in nutrient/fluid entering a gardening container 2A via inlet opening 15 to add oxygen to it. The shape of the pump/filter unit 22 shown in FIG. 4 is also exemplary, and it is considered to be within the scope of the present invention for pump/filter unit 22 to have a different number of perforated walls 38, and for its height and perimeter configuration to be different from that shown in FIG. 4.

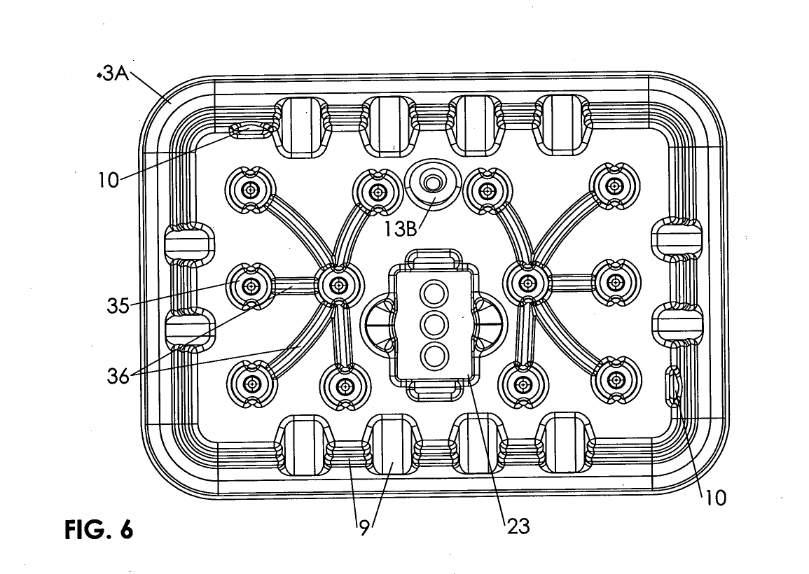

FIGS. 5-8 show views of the reservoir 3A and its cover 4A used as a part of first preferred embodiment 1A, that were previously illustrated in FIGS. 1-4. Reservoir cover 4A locks onto reservoir 3A around it periphery, adding to the structural integrity of both reservoir cover and reservoir 3A, as well as strengthening the side walls of reservoir 3A, which adds compression strength to help hold the weight of gardening containers 2A filled with nutrient/fluid saturated soil. FIG. 5 is a top view of reservoir cover 4A in the first preferred embodiment of the present invention showing the four elevation positioning supports 5A used for supporting each end of the two gardening containers 2A, each elevation positioning support 5A having outlying strengthening gussets 24. For large gardening containers 2A, three or more elevation positioning supports 5A could be used. The two of the elevation positioning supports 5A shown have an arrow 27 and locking tabs 26 to help a user in identifying the correct orientation of gardening containers 2A relative to reservoir cover 4A and alignment of the nutrient/fluid drain hole 28 with the fluid outlet/drain opening 16 in bottom surface of a gardening container 2A for return of surplus nutrient/fluid to reservoir 3A for recycling. FIG. 5 further shows the maintenance access opening 29 in reservoir cover 4A (covered by removable plate 11A in FIG. 4) that provides quick access to the pump/filter unit 22 positioned within reservoir 3A. The indent (not separately numbered) around maintenance access opening 29 allows easier removal of plate 11A, which may be optionally locking to prevent access to reservoir 3A by pets and children. FIG. 5 also shows a pipe 12 with a float near maintenance access opening 29, four holes 30 adjacent to maintenance access opening 29 that may be used to allow electrical connection of solar power generating unit cable 7 to pump/filter unit 22 or an onboard power storage unit (not shown), or for locking removable plate 11A. The notches 32 shown on one end of access opening 29 are used for the exit of nutrient/fluid inlet tubing 8A from reservoir 3A, and may also be used for connection of electrical wiring to pump 40. In addition, FIG. 5 shows strengthening ribs 25 adjacent to maintenance access opening 29 that add flexural strength to reservoir cover 4A for support of gardening containers 2A and the soil they contain, two spiral stars 31 that add strength to reservoir cover 4A and may also provide a sink feature to allow rainwater flow into reservoir 3A, with each spiral star 31 also having a central opening (no number assigned) for extension of a gardening container support 21 through reservoir, cover 4A, and a mount 13A used for securing the lower end of a support 6 for a solar power generating unit 7. Although not shown in FIG. 5, a nutrient/fluid-return hole could be formed into one of the elevation positioning supports 5A (preferably one not having a nutrient/fluid drain hole 28), with the nutrient/fluid return hole sized for connection to a nutrient/fluid return line 8C and ready to be punched out if needed for the recycling of nutrient/fluid in an embodiment of the present invention using a frame (73, 76, or other) instead of support by a reservoir (3A-3D, or other). In contrast, FIG. 6 is a top view of the nutrient/fluid supply reservoir 3A preferred for use in first preferred embodiment 1A. Reservoir 3A is shown without its cover 4A so that its strength-enhancing wall structure 9 can be viewed, which can include but is not limited to gussets (not separately numbered) and the stepped indentations marked by the number 58D in FIG. 3. The strength-enhancing wall structure 9 is exemplary, and its configuration may vary from that shown without departing from the spirit and scope of the present invention as long as it adds structural integrity and stability to reservoir 3A and help to prevent collapse of its side walls under the weight of gardening containers 2A filled with nutrient/fluid saturated soil. FIG. 6 also shows a central positioning guide 23 for securing a pump/filter unit 22 during pump 40 use to recycle nutrient/fluid into gardening containers 2A, in addition to a mount 13B employed for securing the lower end of a support 6 for solar power generating unit 7. The locations of central positioning guide 23 and mount 13B are not limited to that shown in FIG. 6. As further shown in FIG. 6, reservoir 3A in preferred embodiment 1A also has two knock-out 10 in its lower wall on one end and on one side that can be optionally employed for connection of a nutrient/fluid line 8C to reservoir 3A, or emptying large volumes of nutrient/fluid from reservoir 3A. In addition, FIG. 6 shows multiple attachment points 35 integrated into the bottom surface of reservoir 3A for connection of a thermal isolator 17A to the exterior bottom surface of reservoir 3A, and strength-enhancing ribs 36 positioned between attachment points 35. The size, configuration, spaced-apart positioning, and location of attachment points 35 and strength-enhancing ribs 36 are not limited to that shown in FIG. 6, as long as each fulfills its design requirements relative to reservoir 3A, including making the bottom of reservoir 3A rigid and self-contained. Preferably, although not limited thereto, twelve attachment points 35 (as shown in FIG. 6) are preferred in smaller reservoirs (3A-3D, or other), and sixteen attachment points 35 are preferred in larger reservoirs (3A-3D, or other) used as a part of preferred embodiments of the present invention hybrid container-gardening system. Although not shown, when reservoir 3A is used in outdoor locations and subject to rainwater replenishment, one or two overflow holes may be located near the top edge of reservoir 3A.

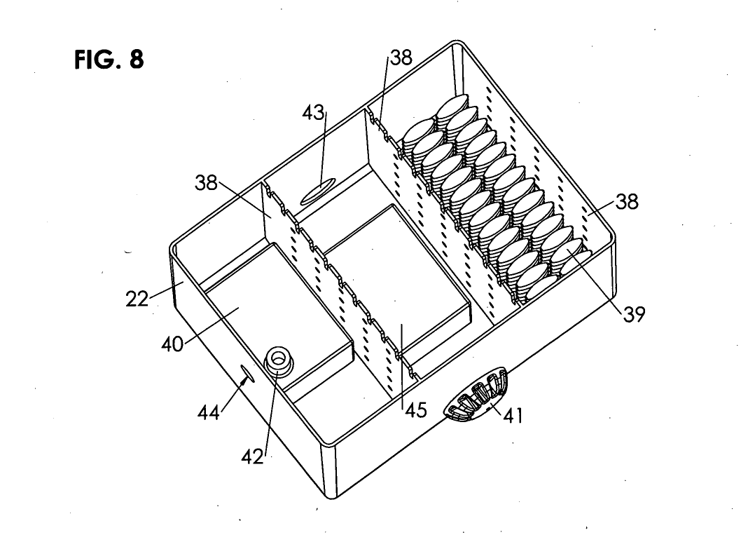

FIG. 7 is a perspective view from the top of the reservoir 3A previously shown in FIGS. 1-4 and 6, and showing a pump/filter unit 22 secured to the central positioning guide 23, the cover 37 of pump/filter unit 22 removed and positioned outside the wall of reservoir 3A to avoid obscuring other structure in reservoir 3A. FIG. 7 further shows pump/filter unit 22 having several perforated walls (see number 38 in FIG. 8) and nutrient/fluid inlet lines 8A connected to one end of pump/filter unit 22, with the opposed free ends of nutrient/fluid inlet lines 8A ready for connection to the inlet openings 15 of two gardening containers 2A supported by reservoir cover 4A. The relative size, configuration, positioning, and end connections of the nutrient/fluid inlet lines 8A illustrated in FIG. 7 are intended to be exemplary, and should not be considered as limiting. However, the tee (not having an independent numerical designation) that splits the nutrient/fluid flow from pump 40 is a preferred feature of first preferred embodiment 1A, so that half of the nutrient/fluid outflow from pump 40 is directed into both gardening containers 2A simultaneously. In addition, FIG. 7 shows the preferred positioning of a mount 13B employed for securing the lower end of a support 6 for solar power generating unit 7 within reservoir 3A, and preferred (but not critical) positioning for a knock-out in a wall of reservoir 3A on one end and on one side for optional connection of a nutrient/fluid return line 8C to reservoir 3A in embodiments of the present invention using a support frame (74, 76, or other) for gardening containers 2A. FIG. 7 further shows the bottom end of a vertically-extending tube 12 with a float secured by one of the attachment points 35, and two optional supports 21 for gardening containers 2A also each secured to different attachment points 35. The two grommets 34 that are associated with the top end of each tubular support 21 during its use with gardening containers 2A is removed from its support 21 and positioned outside the walls of reservoir 3A to avoid obscure the top ends of the tubular supports 21 or other structural features in reservoir 3A. The number of attachment points 35 and strength-enhancing ribs 36 integrated into the bottom surface of reservoir 3A is not limited to that shown in FIG. 7, and must be selected to allow sufficient thermal protection for the bottom surface of reservoir 3A from the ground or other surface supporting it (whether hot or cold), as well as sufficiently strengthen reservoir 3A so that it may hold gardening containers 2A and the amount of nutrient/fluid needed to support growth of plants secured by soil within gardening containers 2A. FIG. 8 is a top view of the pump/filter unit 22 shown in FIGS. 4 and 7, and having three perforated walls 38, one end wall with an opening 44 used for extension therethrough of nutrient/fluid inlet line 8A, and two side walls each with a mounting hole 43 used for support of a vibration isolating connector 41 that assists in securing pump/filter unit 22 to the positioning guide 23 formed in the bottom surface of reservoir 3A when pump 40 is recycling nutrient/fluid to gardening containers 2A. The use of connector 41 is not critical, but preferred, and one is shown in FIG. 8 secured to the near side of pump/filter unit 22. FIG. 8 also shows charcoal filter material 39 situated on one end of pump/filter unit 22 between two perforated walls 38, pump 40 positioned on the opposing end of pump/filter unit 22 from charcoal filter material 39 and between a perforated interior wall 38 and a non-perforated end wall having an opening 44 used for connection of nutrient/fluid inlet line 8A to pump 40. A top fitting on pump 40 shown in FIG. 8 is contemplated for use in providing electrical connection of pump 40 via wiring (not shown) to the solar power generating unit 7 or an on-board battery (not shown). FIG. 8 further shows additional filter material 45 positioned between charcoal filter material 39 and pump 40. The size, configuration and positioning of charcoal filter material 39, additional filter material 45, and pump 40 are merely exemplary and not intended to be limiting. Although not shown, pump/filter unit 22 could also have additional chambers, such as but not limited to a plant nutrient replenishment chamber in which very slowly dissolving nutrient material is housed. In addition, the size of each chamber in pump/filter unit 22 used for housing pump 40 and filter material 39 and 45 are not limited to that shown, and perforated walls 38 may have more or less perforations than are shown in FIG. 8, as well as perforations of differing size and/or placement. Also, even though pump/filter unit 22 is shown having a rectangular perimeter configuration that indicates rigid walls, it is considered to be within the scope of the present invention for pump/filter unit 22 to be in the form of a filter bag.

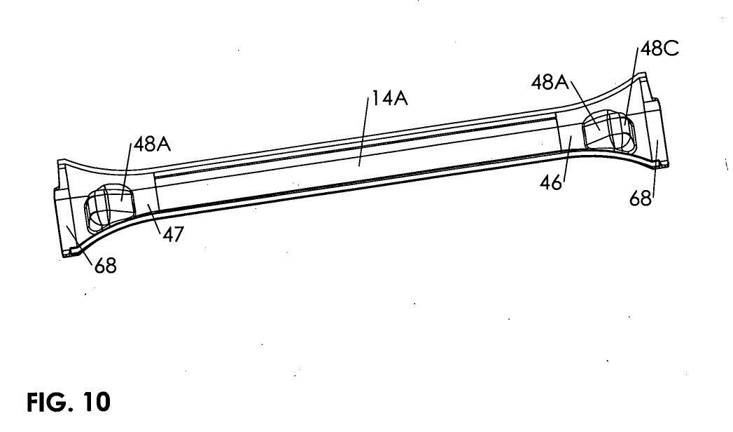

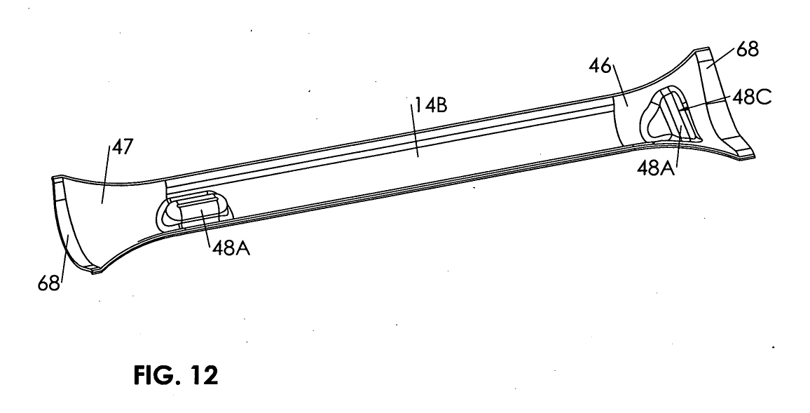

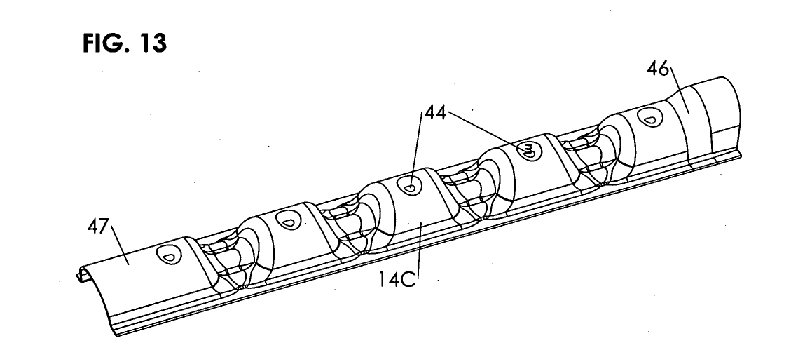

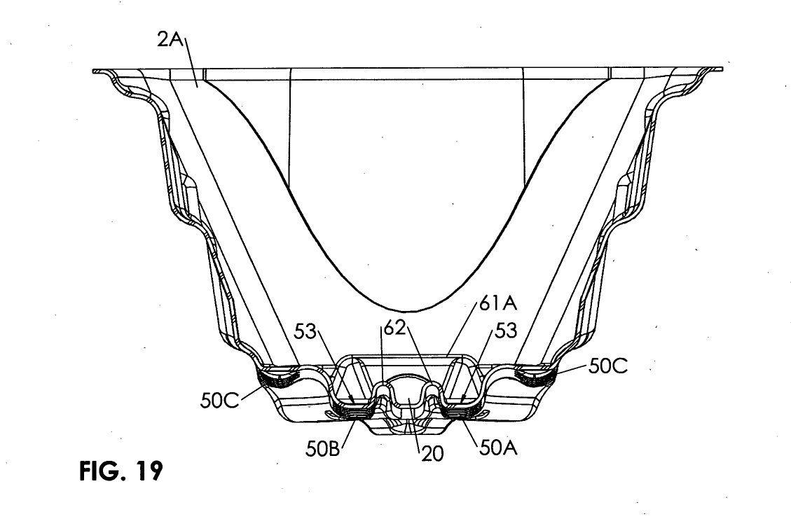

FIGS. 9-13 show the structure of three soil-blocking shields 14A, 14B, and 14C, each of which is elongated and has a generally inverted U-shape. Typically, one elongated soil-blocking shield (14A, 14B, 14C, or other) is used in each gardening container (2a-2E, or other) between fluid inlet opening 15 and fluid drain/outlet opening 16, and once soil-blocking shield (14A, 14B, 14C, or other) is in its desired position of use, soil and plants (or seeds) may be added to the gardening container (2a-2E, or other) above soil-blocking shield (14A, 14B, 14C, or other). It is the weight of soil in gardening containers (2a-2E, or other) that help to seal the ends 68 of soil-blocking shields (14A, 14B, 14C, or other) against the opposed ends (59 and 60) of a gardening container (2a-2E, or other) to prevent potentially blockage-forming soil infiltration into main channel 20 and the nutrient/fluid movement and collection areas adjacent to main channel 20. FIGS. 9 and 10 are perspective views respectively of the top and bottom surfaces of the soil-blocking shield 14A used as a part of the first preferred embodiment 1A of the present invention, and previously shown in FIGS. 1-4 herein. In FIGS. 9 and 10 the nutrient/fluid inlet end of soil-blocking shield 14A is marked by the numeral 46 (which is typically placed near inlet opening 15), and the nutrient/fluid drain/outlet end of soil-blocking shield 14A is marked by the numeral 47 (which would then be placed near the drain/outlet opening 16 of a gardening container 2A). FIGS. 9 and 10 both show soil-blocking shield 14A having an elongated configuration and opposed structured ends 68 each having a configuration complementary to that of a ledge above one of the sealing areas 61 on the opposed ends (59 and 60) of gardening container 2A for closely engaging sealing areas 61 to prevent soil infiltration into main channel 20 and adjacent areas between fluid inlet opening 15 and fluid drain opening 16 where fluid movement and collection occurs. FIG. 10 also shows one downwardly-depending deflector 48A integrated within the inlet end 46 of soil-blocking shield 14A, and a similarly configured and downwardly-depending deflector 48A integrated within the drain/outlet end of soil-blocking shield 14A. The end surface 48C of the inlet end 46 of deflector 48A is used to deflect high-pressure incoming nutrient/fluid to dissipate its force and create turbulence in the incoming nutrient/fluid to oxygenate it. During the manufacturing of soil-blocking shield 14A when downwardly-depending deflector 48A is created, a top indentation 48B becomes positioned in the same location on the reverse (top) surface of soil-blocking shield 14A. The downwardly-depending deflector shown in FIG. 10 on the inlet end 46 of soil-blocking shield 14A also assists in the diversion of nutrient/fluid into peripheral channels 50A and 50B, instead of allowing it to promptly enter main channel 20 and bypass the soil-fluid interface areas in peripheral channels 50A and 50B where slow and consistent uptake of nutrient/fluid occurs as it is drawn into the soil adjacent to plant roots. As soil in and around peripheral channels 50A and 50B becomes fluid saturated, fluid in gardening containers 2A rises even higher where it is drawn into higher elevation peripheral channels 50C until all soil in gardening containers 2A becomes fluid saturated. On the outlet end 47 of soil-blocking shield 14A the downwardly-depending deflector 48A helps to guide and control flow of flow of surplus nutrient/fluid through the gardening container's (2A) nutrient/fluid drain/outlet opening 16. Once the soil in gardening containers 2A becomes saturated and a threshold level of surplus nutrient/fluid has entered gardening container 2A, additional nutrient/fluid entering gardening container 2A via inlet opening 15 will spill over dam 57 and travel down main channel 20 to drain/outlet opening 16 for exit from gardening container 2A and return to reservoir 3A for recycling. FIGS. 11 and 12 are perspective views respectively from the top and bottom of a second preferred embodiment of soil-blocking shield 14B that can also be used as a part of the first preferred embodiment 1A of the present invention. FIGS. 11 and 12 both show soil-blocking shield 14B having an elongated configuration and opposed structured ends 68 each having a configuration complementary to that of a ledge above one of the sealing areas 61 on the opposed ends (59 and 60) of gardening container 2A for closely engaging sealing areas 61 to prevent soil infiltration into main channel 20. However, when comparing soil-blocking shield 14A to soil-blocking shield 14B, one can see that each raised end 68 in soil-blocking shield 14B has a less angular configuration than is show in FIGS. 9 and 10 for soil-blocking shield 14A. Furthermore, the downwardly-depending deflector 48A on the outlet end of soil-blocking shield 14B has a more elongated configuration than is shown in FIGS. 9 and 19 for soil-blocking shield 14A. The end surface 48C of the downwardly-depending deflector 48A shown in FIG. 12 near inlet end 46 of soil-blocking shield 14B is used to deflect high-pressure incoming nutrient/fluid to dissipate its force and create turbulence in the incoming nutrient/fluid to oxygenate it. End surface 48C also helps to divert nutrient/fluid into peripheral channels 50A and 50B, instead of allowing it to immediately enter main channel 20 return to reservoir 3A. Even though the downwardly-depending deflector 48A on the outlet end 47 of soil-blocking shield 14B has a differing configuration from that shown in FIG. 10 for soil blocking shield 14A, the more elongated configuration of the downwardly-depending deflector 48A on the Outlet end 47 of soil-blocking shield 14B also helps to guide and control flow of flow of surplus nutrient/fluid through the gardening container's nutrient/fluid drain/outlet opening 16. In contrast to soil-blocking shields 14A and 14B, FIG. 13 is a perspective view from the side of a third preferred embodiment of soil-blocking shield 14C that is usable in preferred embodiments of the present invention, including preferred embodiment 1A. FIG. 13 shows soil-blocking shield 14C having top openings 49 used for insertion therethrough of a tomato stake (not shown) and/or other plants support, such as but not limited to poles or stakes with a lattice therebetween to provide vertical support for peas and other climbing plants.

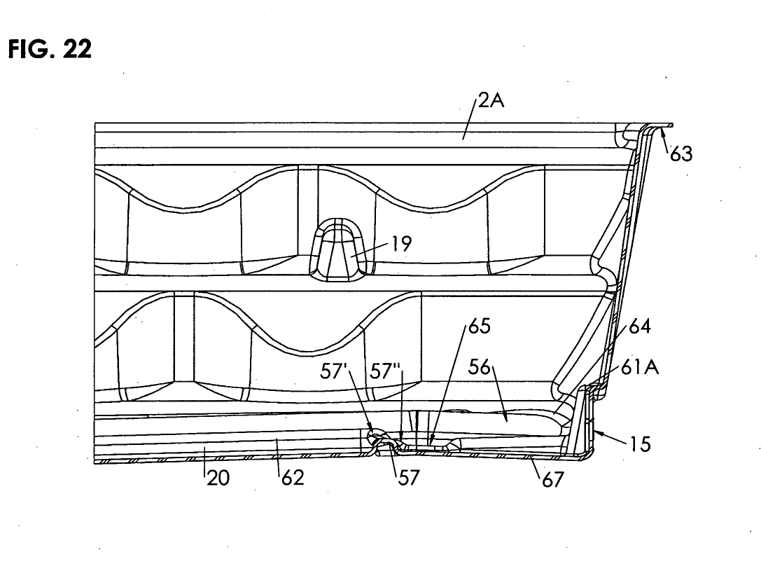

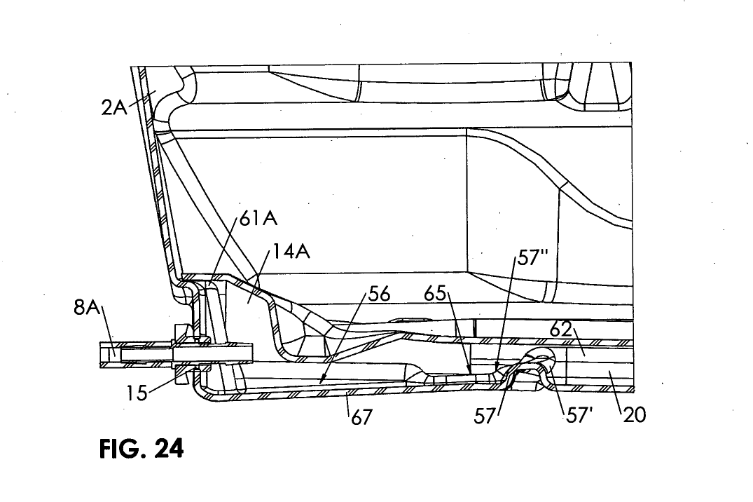

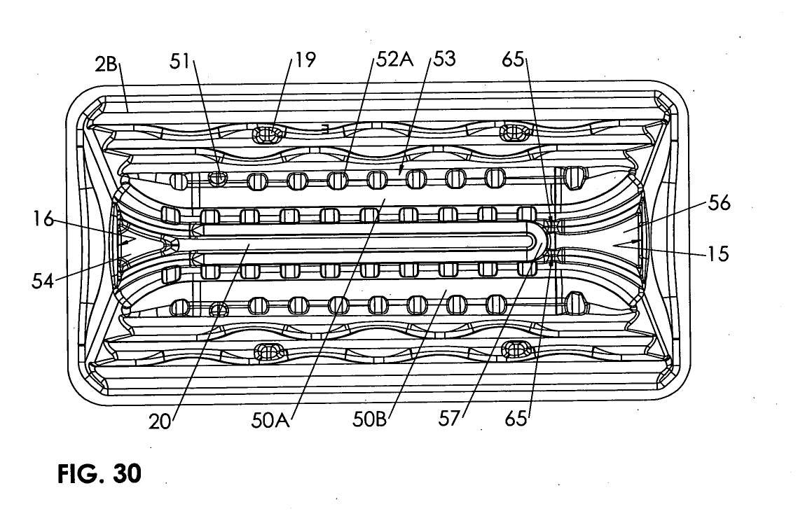

FIGS. 14-25 illustrate the preferred structure of the gardening container 2A used as a part of the first preferred embodiment 1 of the present invention, and previously shown in FIGS. 1-4. FIG. 14 is a top view of the gardening container 2A without a soil-blocking shield (14A-14C) and showing strength-enhancing structure 18 in its side walls, stand-off features 19 in the upper portion of the side walls that allow easy release of gardening containers 2A from one another after stacking. FIG. 14 also shows gardening container 2A having a nutrient/fluid inlet opening 15 and an adjacent inlet basin 56 used for collecting nutrient/fluid, a nutrient/fluid outlet/drain opening 16 and an adjacent outlet basin 54, and an inclined main channel 20 extending between nutrient/fluid inlet opening 15 and outlet/drain opening 16 that is used for transport of surplus nutrient/fluid back to reservoir 3A for recycling. Main channel 20 provides a safety relief function by preventing excessive moisture from building up in the soil present in gardening containers 2A. The size, perimeter configuration, height/elevation, and positioning of inlet opening 15, inlet basin 56, outlet basin 54, outlet/drain opening 16, and main channel 20 may vary in differing embodiments of the present invention from that shown. FIG. 14 further shows gardening container 2A having two peripheral channels 50A and 50B that provide a soil-fluid interface in first preferred embodiment 1A and which are situated in opposing positions on differing sides of main channel 20, a dam 57 at the inlet end of main channel 20 that blocks entry of nutrient/fluid flow into main channel 20 until nutrient/fluid fills inlet basin 56 and has an opportunity to flow into peripheral channels 50A and 50B and saturate the soil in gardening container 2A that surrounds plant roots. Spaced-apart raised pads 52A adjacent to peripheral channels 50A and 50B provide nutrient/fluid pockets 53 between them that trap nutrient/fluid and allow soil in gardening containers 2A to slowly and consistently draw the nutrient/fluid in an upwardly direction toward plant roots, which helps to promote even soil moisture in gardening containers 2A during extended periods of pump 40 inactivity (typically at night, although not limited thereto). The second row of raised pads 52A situated father away from main channel 20 creates pockets 54 at a next higher level (adjacent to higher elevation peripheral channels 50C) that traps nutrient/fluid and helps to maintain even soil moisture throughout the entirety of the soil situated in gardening containers 2A In addition, FIG. 14 shows two locating features 51 in opposed positions to one another that are integral to the lower side walls of the gardening container 2A and used to engage the locking features 26 on reservoir cover 4A to create fixed positioning for gardening containers 2A relative to reservoir cover 4A and also assure that the drain/outlet opening 16 in the bottom of gardening container 2A is properly aligned with the fluid inlet opening 28 in reservoir cover 4A. Locking features 51 further prevent the inadvertent mis-assembly of gardening containers 2A to reservoir cover 2A in first preferred embodiment 1A FIG. 14 also shows the two soil-blocking ledges 61 in the opposing ends 59 and 60 of gardening container 2A (one above inlet opening 15 and the other above drain/outlet opening 16), each of which is engaged by and sealed against soil infiltration from above by the different ends of soil-blocking shield (14A-14C, or other). FIG. 14 further shows the elevated soil-blocking walls 62 around main channel 20, the elongated separator wall 55 around outlet basin 54, and the elongated separator wall 64 around inlet basin 56, and the nutrient/fluid access path 65 extending between inlet basin 56 and peripheral channels 50A and 50B which lets nutrient/fluid flow into peripheral channels 50A and 50B without letting soil infiltration into inlet basin 56. Although the size, shape, and spacing of raised pads 52A and pockets 53 shown in FIG. 14 are preferred in first embodiment 1A, other embodiments also considered within the scope of the present invention may have raised pads 52A and pockets 53 with other sizes, shapes, and spacing. When comparing the length dimension of the elevated soil-blocking walls 62 around main channel 20 in the gardening container 2A (shown in FIG. 14 and having a bottom drain/outlet opening 16) with that in the gardening container 2B (shown in FIG. 30 and having an end drain/outlet opening 16), one will see that the length dimension of the elevated soil-blocking walls 62 around main channel 20 in the gardening container 2A extends closer to outlet basin 54 for added protection against soil intrusion into reservoir 3A via the direct flow of nutrient/fluid into reservoir 3A through the inlet opening 28 on reservoir cover 4A. Comparing the nutrient/fluid access paths 65 shown in FIGS. 14 and 30, one will observe that the nutrient/fluid access path 65 in FIG. 14 is longer to improve water flow into peripheral channels 50A and 50B and prevent soil blockages due to potential soil infiltration. Another difference that can be noted in comparing the gardening container 2A shown in FIG. 14 with the gardening container 2B shown in FIG. 30, is that the dam 57 positioned between main channel 20 and inlet opening 15 in FIG. 30 has a uniform appearance, while the dam 57 shown in FIG. 14 has a safety flow passage (marked by the number 57′ in FIGS. 22 and 24) that more easily directs surplus nutrient/fluid into main channel 20 and prevents too much nutrient/fluid from flowing into peripheral channels 50A and 50B and over-saturating surrounding soil.

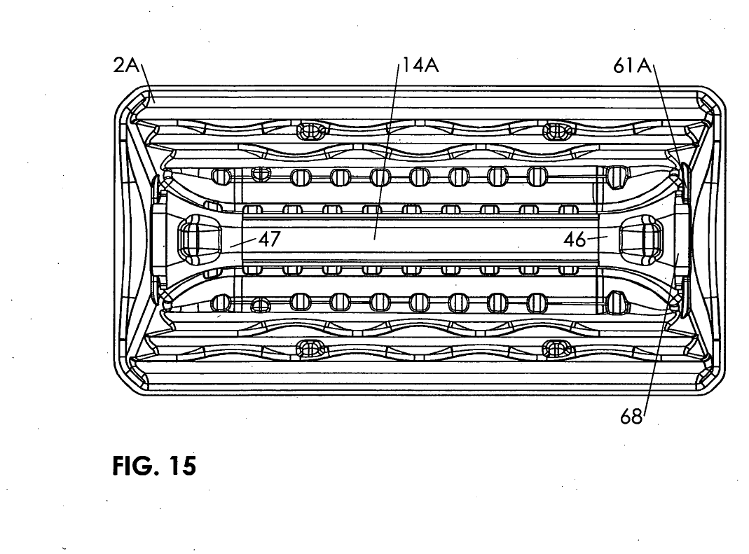

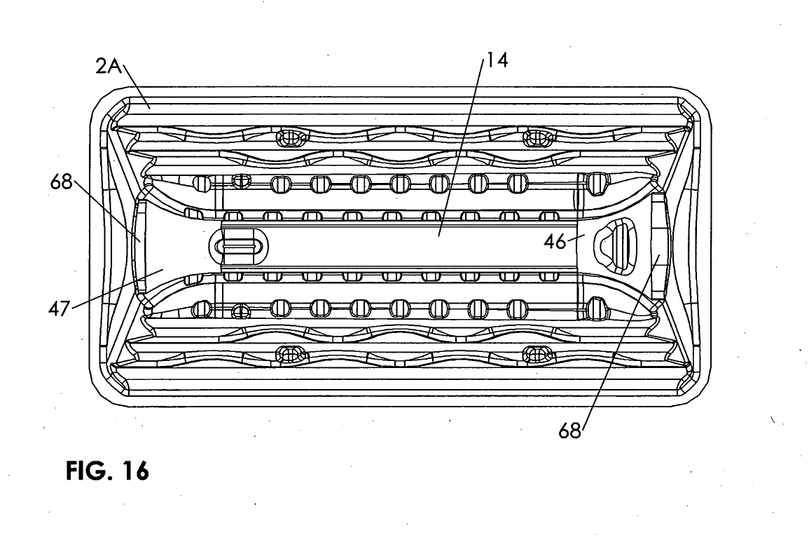

FIGS. 15 and 16 are respectively top views of the soil-blocking shields 14A and 14B positioned over the main channel 20 of gardening container 2A, and show the raised pads 52A and pockets 53 adjacent to peripheral channels 50A and 50B that provide the soil-fluid interface assisting slow and consistent uptake of nutrient/fluid into soil supporting plant roots in gardening containers 2A above soil-blocking shields 14A and 14B, as well as above the peripheral channels 50A and 50B. The inlet end 46 and the outlet end 47 of soil-blocking shields 14A and 14B are identified in FIGS. 15 and 16, as well as the structured ends 68 of soil-blocking shields 14A and 14B that are configured to be complementary in configuration to, and closely engage, the soil-blocking ledge in the sealing areas 61 on the ends of gardening containers 2A to prevent soil infiltration into main channel 20, outlet basin 54, inlet basin 56, and the nutrient/fluid access path 65 extending between inlet basin 56 and peripheral channels 50A and 50B to prevent soil blockages that might otherwise occur and interrupt nutrient/fluid flow within, or between, gardening containers 2A.

FIGS. 17-25 further explain and identify the flow of nutrient/fluid through the gardening containers 2A of first preferred embodiment 1A, and other structure in gardening containers 2A. FIG. 17 is a perspective view from the drain/outlet end 59 of gardening container 2A and shows the bottom surface positioning of the nutrient/fluid outlet/drain opening 16, as well as the strength-enhancing structure 18 in side walls that also incorporate sculpted indentations 58A-58C, permitting support of gardening containers 2A in stepped gravity-feed arrangement by a frame (such as but not limited to frames 73 and 76) without collapse of the side walls of gardening containers 2A. FIG. 17 also shows a punch-out hole 66 in the drain/outlet end 59 of gardening container 2A used with a return drain/outlet line 8C should the gardening container 2A thereafter become employed as a part of a preferred embodiment of the present invention that is supported by a frame 73 or 76 instead of reservoir 3A and its cover 4A. Although not illustrated herein, provisions for sealing the downwardly directed drain/outlet opening 16 of gardening container 2A would be required. Although first preferred embodiment 1A is shown to have a nutrient/fluid outlet/drain opening 16′ positioned through the bottom surface of gardening container 2A, positioning of drain/outlet openings 16 in other preferred embodiments of the present invention may extend through an end of gardening container 2a, or through one of its side walls as long as connection through a side wall does not interfere with the soil-fluid interface areas of gardening container (2A or other).

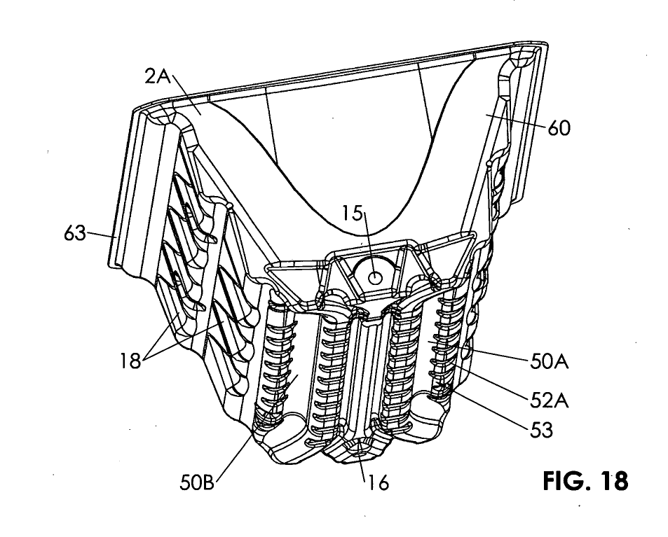

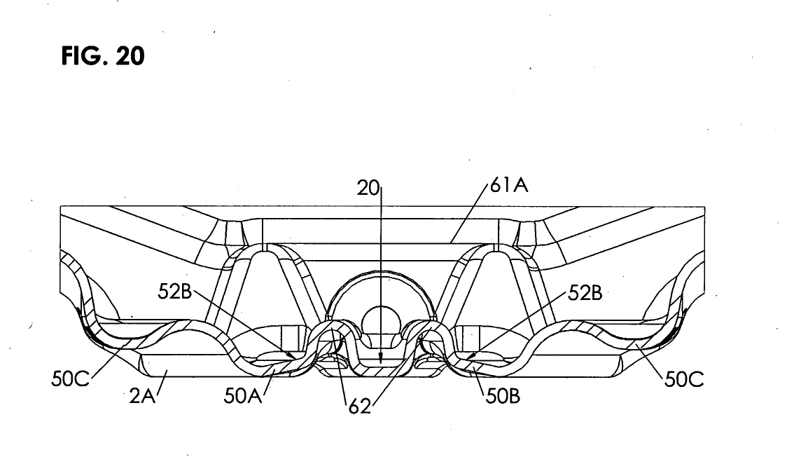

FIG. 18 is a perspective view from the inlet end 60 of gardening container 2A and showing a nutrient/fluid inlet opening 15 on inlet end 60, a nutrient/fluid outlet/drain opening 16 through the bottom surface of gardening container 2A, and the preferred positioning of main 20 and peripheral channels 50A and 50B integral to the bottom surface of gardening container 2A. Raised pads 52A and the pockets 53 formed between raised pads 52A are also visible in FIG. 18. In addition, FIG. 18 shows the strength-enhanced side wall structure 18 of gardening container 2A, and a reinforced upper edge 63 that dips in slightly for easy maneuvering of gardening container 2A. The indent (not separately marked with a numerical designation) shown around inlet opening 15 under an arch-shaped structure functions as a quick-locate feature for making connections of nutrient/fluid lines 8A-8C. In contrast, FIG. 19 is a section view of the drain/outlet end 59 of the gardening container 2A in first preferred embodiment 1A, which shows the substantially horizontally-extending configuration of fluid collection pockets 53 (between the raised pads 52A which are not visible in the section) in peripheral channels 50A and 50B. FIG. 19 also identifies the positioning of the soil-blocking ledge in sealing area 61 on the end of gardening container 2A and the soil-blocking walls of main channel 20. The section view of FIG. 19 further shows two opposed peripheral channels 50C at a higher elevation within gardening container 2A than peripheral channels 50A and 50B, which serve the same function of providing a slow and consistent uptake of nutrient fluid into soil within gardening container 2A to the point of saturation, but allowing over-saturation. In contrast, FIG. 20 is an enlarged section view of the inlet end 60 of a gardening container 2A that shows an alternative structure for raised pads 52B located in peripheral channels 50A and 50B of preferred embodiments of the present invention, which shows the top surfaces of raised pads 52B having an angled configuration away from main channel 20 to divert accumulation of nutrient/fluid away from soil-blocking shield (14A-14C, or other) that reduces the opportunity for soil infiltration under it. Although not visible in the section view of FIG. 20, the bottom surfaces of peripheral channels 50A and 50B typically remain flat, with only the top surfaces of raised pads 50B having an angled configuration away from the elevated soil-blocking wall 62 around main channel 20. FIG. 20 also shows the positioning of the soil-blocking ledge in sealing area 61, the soil-blocking walls of main channel 20, and the two opposed peripheral channels 50C at a higher elevation within gardening container 2A than peripheral channels 50A and 50B.

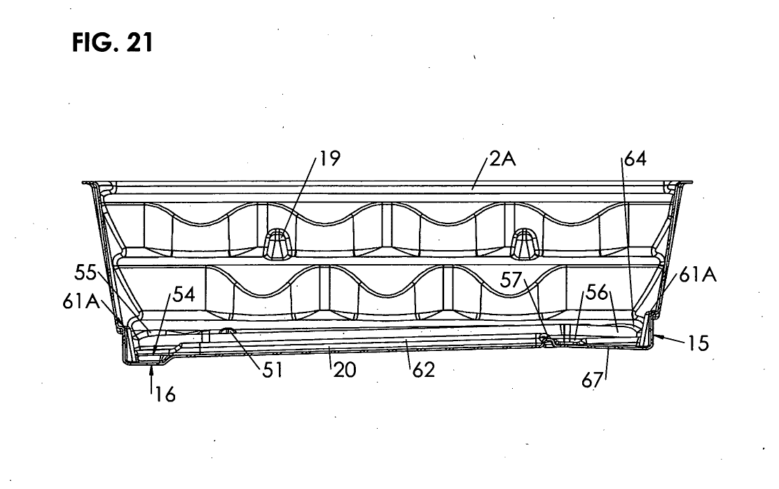

FIGS. 21-25 are section views from the side of gardening container 2A that further demonstrate the generally longitudinal flow of surplus nutrient/fluid through it. FIG. 21 is a section view from the side of gardening container 2A having a nutrient/fluid inlet opening 15 on one of its ends, a bottom nutrient/fluid outlet/drain opening 16 near its opposing end that is lower in elevation than inlet opening 15, and a main channel 20 extending between the inlet opening 15 and drain/outlet opening 16 and downwardly inclined toward drain/outlet opening 16. FIG. 21 also shows the nutrient/fluid collecting basins 56 and 54 respectively located near the opposing ends 60 and 59 of gardening container 2A adjacent to inlet and drain/outlet openings 15 and 16, as well as the optional small reverse slope 67 situated between a dam/spillway 57 at the head of inclined main channel 20 and inlet opening 15 (in part under basin 56) that allows nutrient/fluid to fill basin 56 and then travel through nutrient/fluid access path 65 (see FIG. 14) into peripheral channels 50A and 50B where nutrient/fluid flow is significantly slowed upon contact with soil. Reverse slope 67 can be useful then the patio or other surface upon which first preferred embodiment 1A is placed is not level. FIG. 21 further identifies the elevated soil-blocking walls 62 of main channel 20, the elongated separator walls 55 and 64 respectively around outlet basin 54 and inlet basin 56, the stand-off features 19 that assist in separating stacked gardening containers 2A from one another, and the opposed ledges in the sealing areas 61A on the ends 59 and 50 of gardening container 2A that are used for sealing the opposing ends 68 of a soil-blocking shield (14A-14C, or other) against the ends 59 and 50 of gardening container 2A to prevent soil infiltration and blockages in areas (other than soil-fluid interfaces in peripheral channels 50A and 50B) used for collection and movement of surplus nutrient/fluid.

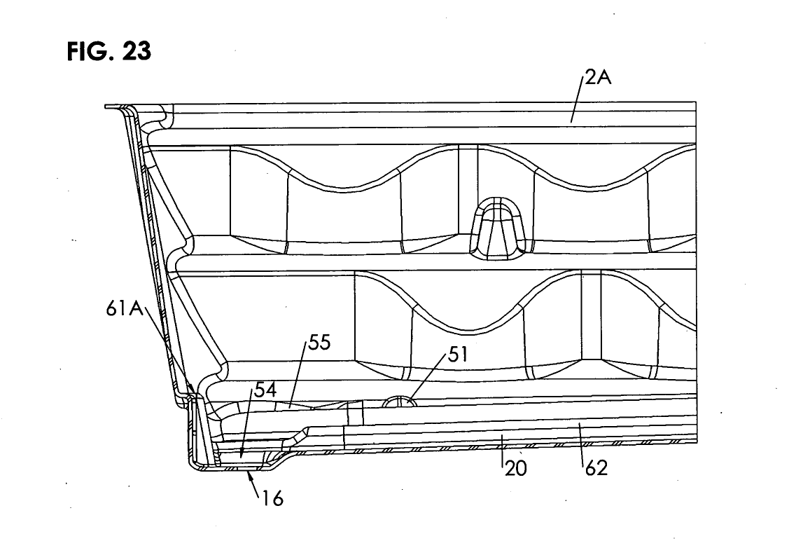

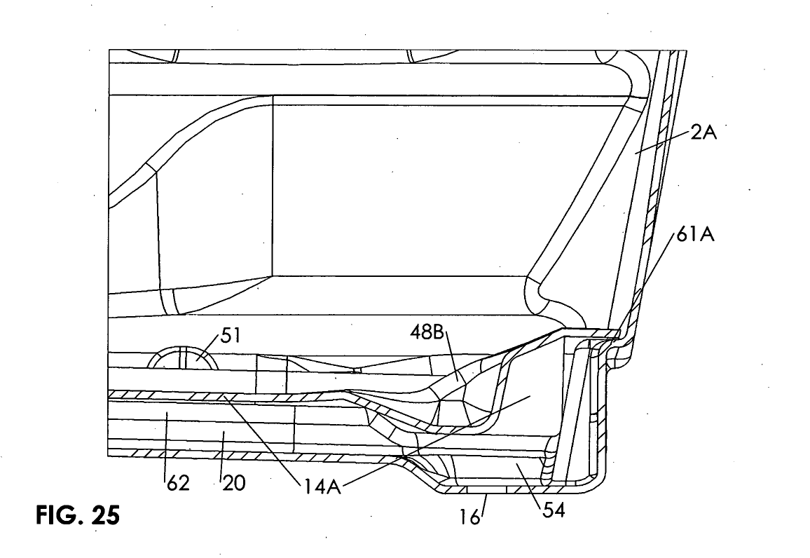

FIGS. 22 and 23 are enlarged views of the illustration of gardening container 2A shown in FIG. 21, with FIGS. 24 and 25 showing similar section views to those in FIGS. 22 and 23, except that a soil-blocking shield has been added for additional reference. FIG. 22 is an enlarged section view from the side of the nutrient/fluid inlet end 60 of the gardening container 2A shown in FIG. 21 with a nutrient/fluid collecting basin 56 near inlet opening 15, a dam/spillway 57 positioned adjacent to basin 56 in a remote position from inlet opening 15, and an inclined main channel 20 on the far side of dam/spillway 57 that receives surplus nutrient/fluid entering gardening container 2A through inlet opening 15 after the soil in gardening container 2A becomes saturated with nutrient/fluid. Once the soil in gardening container 2A becomes saturated with nutrient/fluid, surplus nutrient/fluid then moves into main channel 20 which functions to provide safety relief to prevent excess moisture build-up in the soil in gardening container 2A around plant roots. Thus, it is intended for nutrient/fluid to flow freely (via gravity-feed) through main channel 20. FIG. 22 also shows the elevated soil-blocking wall 62 of main channel 20, the elongated separator wall 64 around inlet basin 56, the small reverse slope 67 in the bottom surface of gardening container 2A situated between dam/spillway 57 and inlet opening 15 that allows nutrient/fluid to fill basin 56 and reach a threshold level that allows it to travel across nutrient/fluid access path 65 and into peripheral channels 50A and 50B without soil infiltration into basin 56, a stand-off feature 19 that assists in separating stacked gardening containers 2A from one another, and a ledge in the sealing area 61A above nutrient/fluid inlet opening 15 that is used for sealing one end 68 of a soil-blocking shield (14A-14C, or other) against the inlet end 60 of gardening container 2A to prevent soil from dropping down into inlet basin 56 and main channel 20. In contrast, FIG. 23 is an enlarged section view from the side of the nutrient/fluid drain/outlet end 59 of the gardening container 2A shown in FIG. 21, with a nutrient/fluid collecting outlet basin 54 positioned above the drain/outlet opening 16 in the bottom surface of gardening container 2A. FIG. 23 also shows the inclined main channel 20 having fluid communication with outlet basin 54, the elongated separator wall 55 around outlet basin 54 and the elevated soil-blocking wall 62 of main channel 20, one of the locating features 51 on bottom of gardening container 2A that engages a locking tab 26 on a reservoir cover (4A or other), and a ledge in the sealing area 61A above nutrient/fluid outlet opening 16 that is used for sealing one end 68 of a soil-blocking shield (14A-14C, or other) against the outlet end 59 of gardening container 2A to prevent soil from dropping down into outlet basin 54 and main channel 20. One of the important functions of basins 54 and 56 is for them to act as a sink to ensure that the majority of nutrient/fluid drains from around plant roots when pump 40 is inactive, leaving only a controlled amount of nutrient/fluid for the soil to thereafter absorb until the recycling of nutrient/fluid from reservoir 3A continues. Basins 54 and 56 also act as a safety factor to compensate for uneven ground, and basin 56 (near inlet opening 15) also facilitates nutrient/fluid flow from one gardening container 2A to another via gravity-feed in transport lines 8B. FIG. 24 is an enlarged section view from the side similar to that illustrated in FIG. 22, showing one end of a soil-blocking shield 14A positioned adjacent to the inlet end 60 of gardening container 2A and engaging the ledge in the sealing area 61A above inlet opening 15, with more of the soil-blocking shield 14A extending over dam 57 and main channel 20. FIG. 24 also shows the relative positioning of soil-blocking shield 14A to inlet basin 56, the elevated soil-blocking wall 62 of main channel 20, dam/spillway 57, the small reverse slope 67 in the bottom surface of gardening container 2A under inlet basin 56, and the nutrient/fluid inlet line 8A connected to inlet opening 15. FIG. 25 is an enlarged section view from the side that is similar to the view illustrated in FIG. 23, showing one end of a soil-blocking shield 14A (with the indented top portion of its deflector 48A) positioned adjacent to the drain/outlet end 59 of gardening container 2A and engaging the ledge in the sealing area 61A above drain/outlet opening 16, with the soil-blocking shield 14A extending over the basin 56, main channel 20, and the elevated soil-blocking wall 62 around main channel 20. FIG. 25 also shows main channel 20 having fluid communication with outlet basin 54 and identifies one of the locating features 51 on bottom of gardening container 2A that engages a locking tab 26 on a reservoir cover (4A or other) to assist alignment of fluid communication between gardening container 2A and a reservoir cover (4A or other) supporting it. FIGS. 22 and 24 also show dam 57 having a safety flow passage 57 that more easily directs surplus nutrient/fluid into main channel 20 and prevents too much nutrient/fluid from flowing into peripheral channels 50A and 50B and over-saturating surrounding soil. In addition, FIGS. 22 and 24 identify a surface related to nutrient access path 65 and situated between primary dam 57 and nutrient access path 65 that functions as a secondary dam 57″.

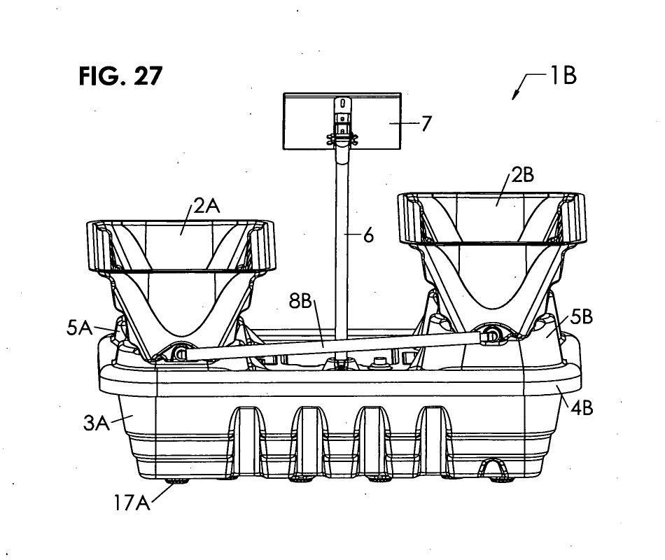

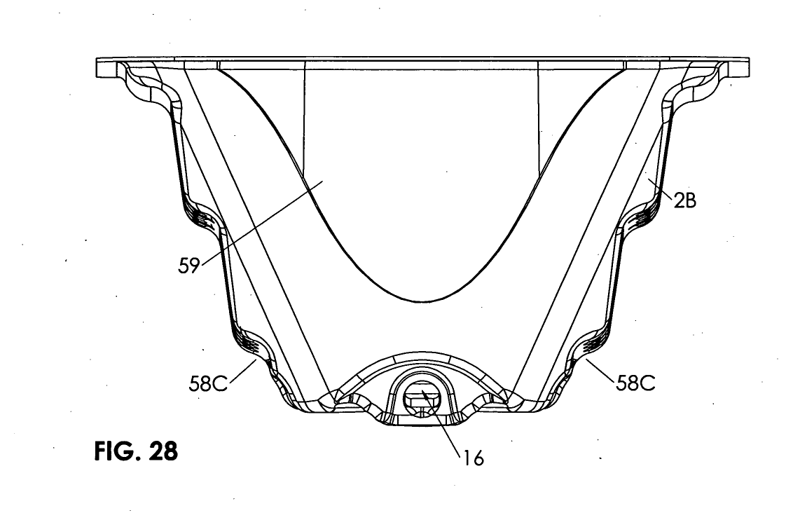

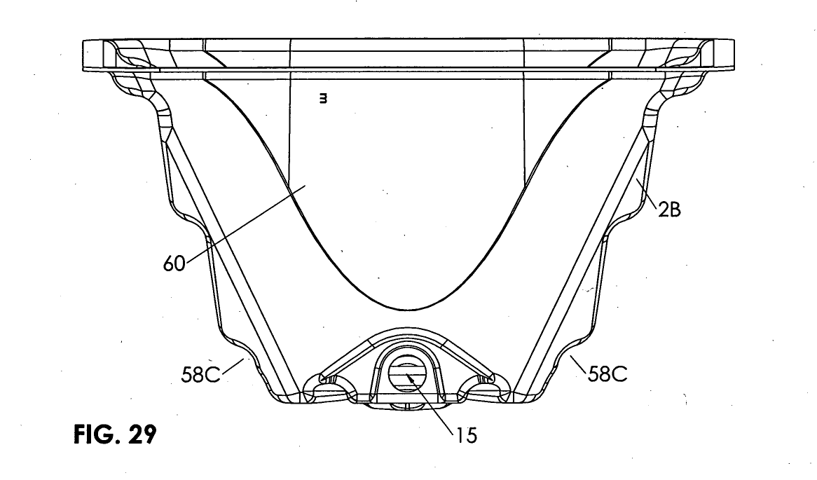

FIGS. 26-30 show a second preferred embodiment 1B of the present invention hybrid container-gardening system. FIG. 26 is a perspective view from the front of second preferred embodiment 1B showing two gardening containers (2A and 2B) supported upon a reservoir cover 4B at differing elevations respectively by elevation positioning supports 5A and 5B, and a nutrient/fluid transport line 8B connected between gardening containers 2A and 2B so that only gardening container 2A empties surplus nutrient/fluid through reservoir cover 4B and into reservoir 3A. When gardening containers 2A and 2B are at different elevations, gravity-feed of nutrient/fluid is encouraged even when uneven ground supports reservoir 3A. A nutrient/fluid inlet line 8A is not shown in FIG. 26 between inlet opening 15 in gardening container 2B and reservoir 3A, but would be required for operation of second preferred embodiment 1B. FIG. 26 also shows second preferred embodiment 1B having a solar power generating unit 7 secured to a support 6, a removable plate 11A over the maintenance access opening 29 in reservoir cover 4B, and rubber feet or other thermal insulator 17A attached to the exterior bottom surface of reservoir 3A to prevent thermal conduction between reservoir 3A and the ground or other surface supporting it, which otherwise might cause a sufficient temperature increase or decrease in the nutrient/fluid contained by reservoir 3A to negatively impact root/plant growth in plants supported by soil in gardening containers 2A and 2B. FIG. 27 is a perspective view from the rear of the second preferred embodiment 1B shown in FIG. 26, which more clearly shows the nutrient/fluid transport line 8B connection between gardening containers 2A and 2B. As in FIG. 26, FIG. 27 also shows solar power generating unit 7 and support 6, removable plate 11A, and rubber feet or other thermal insulator 17A attached to the exterior bottom surface of reservoir 3A. FIGS. 28 and 29 show end views of the gardening container 2B used as a part of second preferred embodiment 1B, while FIG. 30 shows a top view of gardening container 2B without a soil-blocking shield (14A or other). FIG. 28 is a drain/outlet end 59 view of the gardening container 2B that shows its end-positioned nutrient/fluid drain/outlet opening 16 and the sculpted indentations 58C on opposing sides of gardening container 2B that allows support thereof by high elevation positioning supports 5B on reservoir cover 4B. Similarly, FIG. 29 is a nutrient/fluid inlet end 60 view of gardening container 2B that shows its nutrient/fluid inlet opening 15 through one end of gardening container 2B and its sculpted indentations 58C. FIG. 30 is a top view of the gardening container 2B used in second preferred embodiment 1B, which shows its drain/outlet opening 16 and adjacent outlet basin 54 used to collect excess nutrient/fluid prior to its exit through outlet/drain opening 16, its nutrient/fluid inlet opening 15 and adjacent inlet basin 56 where nutrient/fluid collects prior to diversion into the soil-fluid interface areas in peripheral channels 50A and 50B, and the nutrient/fluid access path 65 providing fluid communication between inlet basin 56 and peripheral channels 50A and 50B. Although the outlet basin 54 is larger than that shown in FIG. 14 for gardening container 2A, the nutrient access path is narrower than that shown in FIG. 14 for gardening container 2A, and the ledge in the sealing area 61 is less pronounced that that shown in FIG. 1 for gardening container 2A, the remaining structural features of gardening container 2B appear to have substantial similarity to comparable structural features shown in FIG. 14 for gardening container 2A, including dam 57, locating features 51, stand-off features 19, and the spaced-apart raised pads 52A and pockets 53 spaced along the length of gardening container 2B.

FIGS. 31 and 32 show a third preferred embodiment 1C of the present invention hybrid container-gardening system, with FIG. 31 showing the entire system in third preferred embodiment 1C and FIG. 32 showing reservoir 3B and reservoir cover 4C without any supported gardening containers 2C. FIG. 31 is a perspective view from the front of third preferred embodiment 1C having two gardening containers 2C (with soil-blocking shields 14C) at differing elevations for gravity-assisted flow between them, with one broken arrow showing nutrient/fluid flow from the raised fluid transport opening 69 in reservoir cover 4C to the inlet opening 15 on the gardening container 2C having the higher elevation and a second broken arrow showing nutrient/fluid flow from the drain/outlet opening 16 in the lower gardening container 2C to the raised fluid transport opening 69 in reservoir cover 4C for reentry of surplus nutrient/fluid back into reservoir 3B for recycling. A nutrient/fluid transport line 8B is not shown in FIG. 31 between gardening containers 2C, but would be required for operation of third preferred embodiment 1C. Furthermore, since elevation positioning supports 5A and 5A′ may have differing height dimensions (with elevation positioning support 5A being higher than support 5A′), and in addition elevation positioning supports 5B and 5B′ may have differing height dimensions (with elevation positioning support 5B higher than support 5B′), gravity-feed assist for movement of surplus nutrient/fluid back into reservoir 3B for recycling may not need additional incline in the main channels 20 of gardening containers 2C (although an inclined main channel 20 could be provided in gardening containers 2C). FIG. 31 also shows reservoir cover 4C having a removable plate 11B with a handle to provide access to the pump/filter unit 22 located in reservoir 3B. In addition, FIG. 31 shows the stepped indentations 58D in the walls of reservoir 3B that add strength and rigidity to help prevent reservoir 3B from collapsing under the weight of the soil-filled gardening containers it supports (2A-2E, or other). As can be seen in FIG. 31 stepped indentations 58D become progressively larger, with the topmost stepped indentation 58D having the largest exterior dimension.

FIG. 32 is a perspective view from the top of the reservoir 3B and reservoir cover 4C in third preferred embodiment 1C that shows elevation positioning supports (5A, 5A′, 5B, and 5B′) on reservoir cover 4C and the height dimensions of the elevation positioning supports (5A/5A′ and 5B/5B′) intended for support of the same gardening container 2C being slightly different to encourage gravity-assisted nutrient/fluid flow toward the drain/outlet 16 of gardening container 2C whether gardening containers 2C have an inclined main channel 20, or not. The strength-enhancing extensions 24 on the higher elevation positioning supports (5B and 5B′) are also shown in FIG. 32, as well as the raised fluid transport opening 69 in reservoir cover 4C for transport of nutrient/fluid from and to reservoir 3B. FIG. 32 further show reinforced openings 71 through reservoir cover 3B through which the top portion of an optional tubular support 21 may extend to make contact with the bottom surface of a gardening container 2C. In addition, FIG. 32 shows strength-enhancing ribs 36 on reservoir cover 4C between elevation positioning supports (5A, 5A′, 5B, and 5B′), a removable plate 11B with a handle that allows easy access to the pump/filter unit 22 located within reservoir 3B, and a positioning guide 70 on reservoir cover 4C that allows easy alignment/installation of plate 11B. The size, number, configuration, and positioning of the strength-enhancing extensions 24 and the strength-enhancing ribs 36 shown in FIG. 32 are not critical as long as the intended strengthening functions are fulfilled.

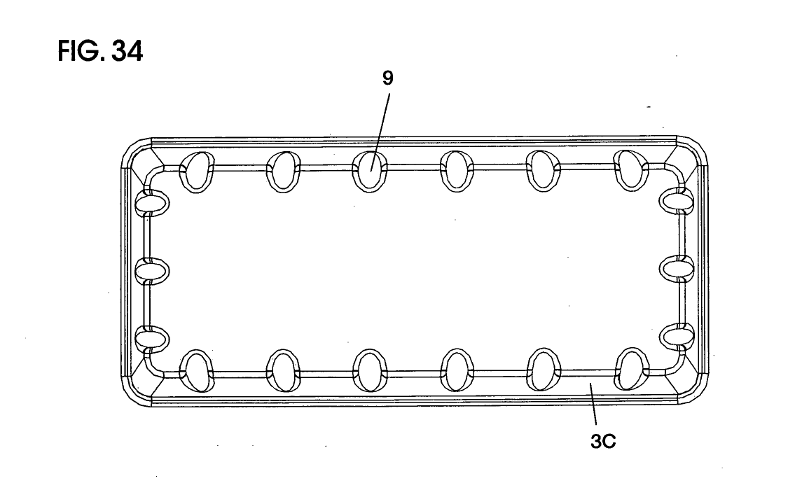

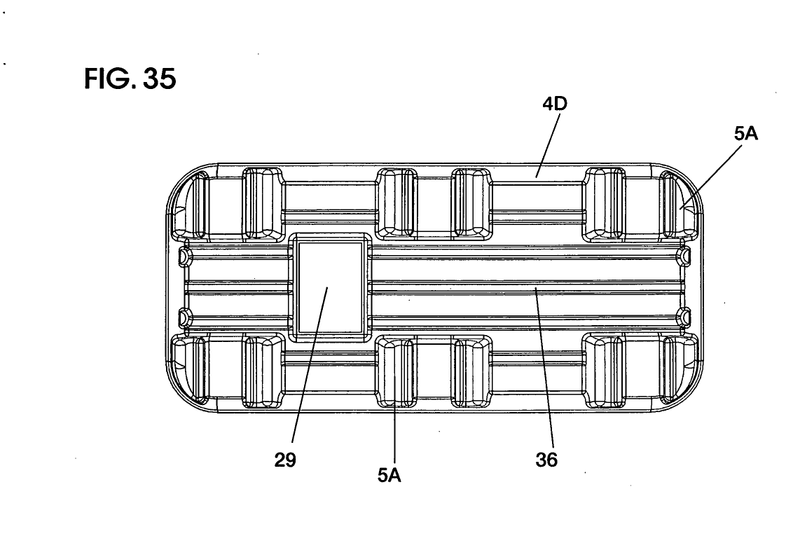

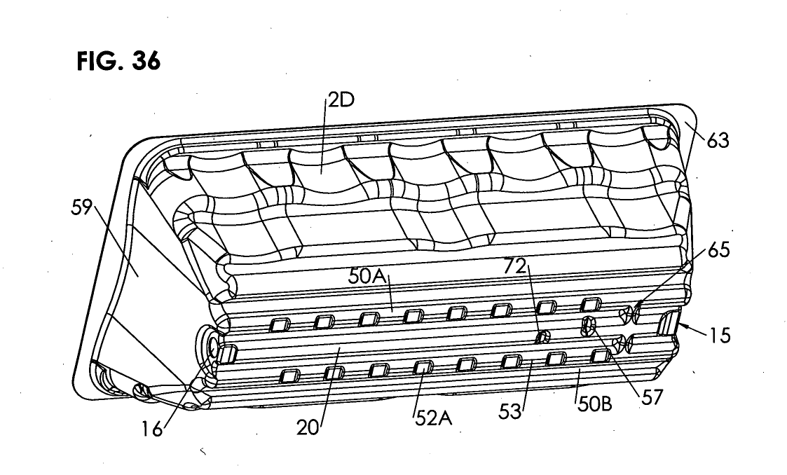

FIGS. 33-40 show a fourth preferred embodiment 1D of the present invention hybrid container-gardening system, with FIG. 34 showing an additional view of reservoir 3C, FIG. 35 showing an additional view of reservoir cover 4D, and FIGS. 36-40 showing additional views of gardening containers 2D. FIG. 33 is a perspective view from the top of fourth preferred embodiment 1D having three gardening containers 2D supported at substantially the same elevation by a reservoir 3C and its cover 4D. Although nutrient/fluid transport lines (8A-8C) are not shown in FIG. 33, they would be required for operation of fourth preferred embodiment 1D. FIG. 33 also identifies elevation positioning supports 5A and strength-enhancing ribs 36 in reservoir cover 4D, a removable plate 11B with a handle that allows easy access to the pump/filter unit 22 located within reservoir 3C, strength-enhancing structure 9 in the walls of reservoir 3C, and a soil-blocking shield 3C longitudinally positioned within each gardening container 2D. FIG. 34 is a bottom view of reservoir 3C that shows its strength-enhancing features 9 that are a continuation of the strength-enhancing structure 9 in the walls of reservoir 3C, while FIG. 35 is a perspective view from the top of reservoir cover 4B that shows its strength-enhancing ribs 36, elevation positioning supports 5A each having substantially the same height dimension, and a maintenance access opening 29.

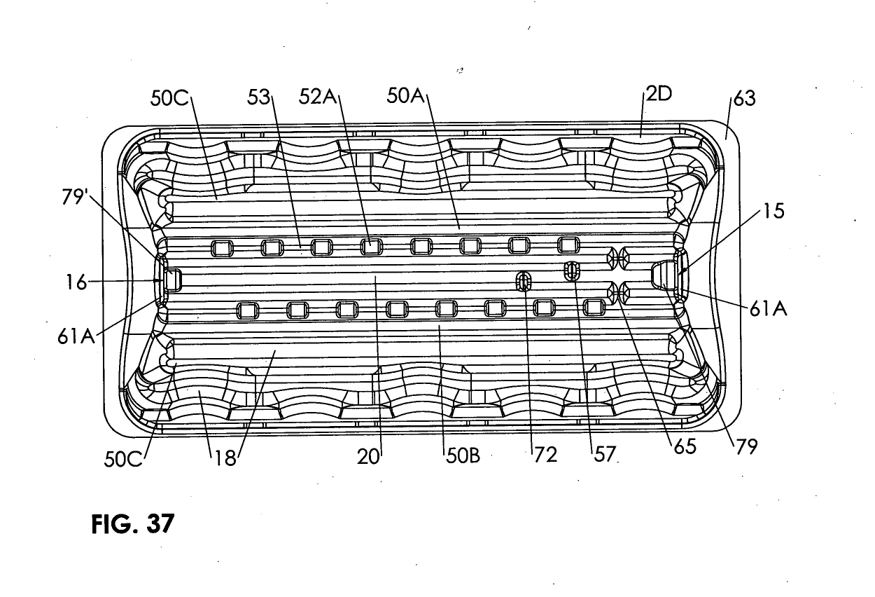

FIGS. 36-40 reveal additional structure in gardening containers 2D. FIG. 36 is a perspective view from the bottom of gardening container 2D that shows the preferred end positioning of its nutrient/fluid inlet opening 15 and the opposed nutrient/fluid drain/outlet opening 16 on the outlet end 59 of gardening container 2D. FIG. 36 further shows main channel 20 extending between the inlet and outlet openings 15/16 that is used for travel of surplus nutrient/fluid to drain/outlet opening 16 after soil positioned within gardening container 2D becomes saturated with nutrient/fluid and additional nutrient/fluid enters gardening container 2D. In addition, FIG. 36 shows the positioning near main channel 20 of two peripheral channels 50A and 50B containing raised pads 52A and nutrient/fluid containing pockets 53 that provide a soil-fluid interface and from which nutrient/fluid slowly and consistently moves in an upwardly direction into the soil for plant root uptake until soil saturation occurs, the access path 65 through which some nutrient/fluid entering gardening container 2D through inlet opening 15 moves into one of the peripheral channels 50A or 50B, a primary dam 57 which slows travel of nutrient/fluid into main channel 20 and instead allows some of it to collect near nutrient/fluid inlet opening 15 for its later movement into peripheral channels 50A and 50B, a small nutrient/fluid diverting obstruction 72 positioned between dam 57 and drain outlet opening 16 that slows nutrient/fluid flow through main channel 20 also provides oxygenation of nutrient/fluid, and a reinforced curved upper edge 63 that can be used as a handle for easy manual lifting and transport of empty gardening containers 2D or those containing dry soil. It is likely that a gardening container filled with nutrient/fluid soil and plants would be too heavy for many people to lift. FIG. 37 is top view of gardening container 2D that shows most of the same features of gardening container 2D visible in FIG. 36, including the main channel 20 longitudinally extending between the nutrient/fluid inlet opening 15 and nutrient/fluid drain/outlet opening 16, the two longitudinally-extending peripheral channels 50A and 50B adjacent to main channel 20, primary dam 57, nutrient/fluid diverting obstruction 72 positioned in main channel 20, reinforced curved upper edge 63, and the nutrient/fluid access path 65 through which some nutrient/fluid entering gardening container 2D through its inlet opening 15 moves into a peripheral channel 50A or 50B. In addition, FIG. 37 shows the downwardly-inclined ramps 79 and 79′ adjacent to the inlet and drain/outlet openings 15/16 that promote accumulation of nutrient/fluid adjacent thereto for use when pump 40 shuts off, and the ledges in the sealing areas 61A above the inlet and drain/outlet openings 15/16 that assist in providing sealing contact between the end wall of gardening container 2D and one end of the soil-blocking shield (14A-14C or other) to prevent soil infiltration into main channel 20. Ramps 79 and 79′ also help to compensate for uneven support of reservoir 3C by the ground, patio, or balcony, and facilitate nutrient/fluid flow from one gardening container 2A to another via gravity-feed in transport lines 8B.

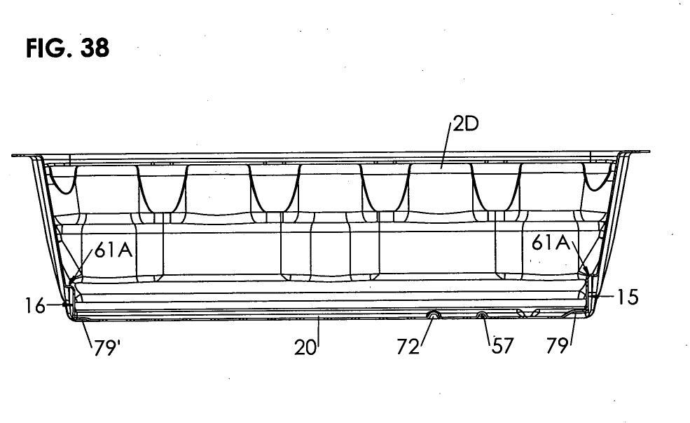

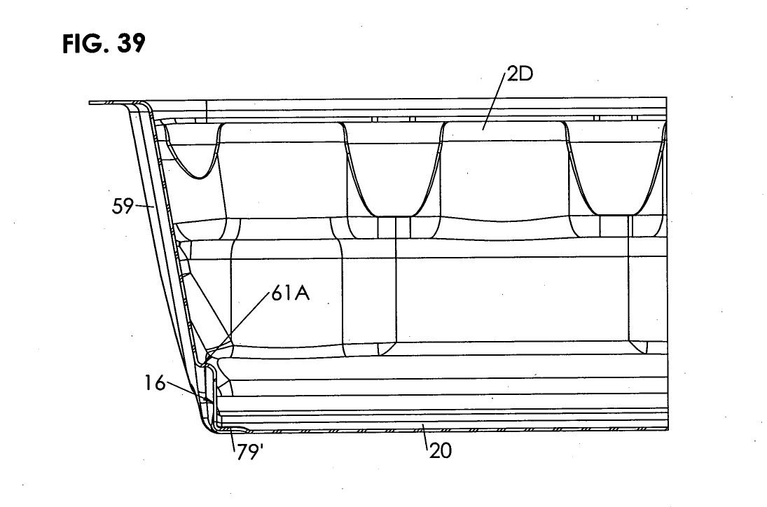

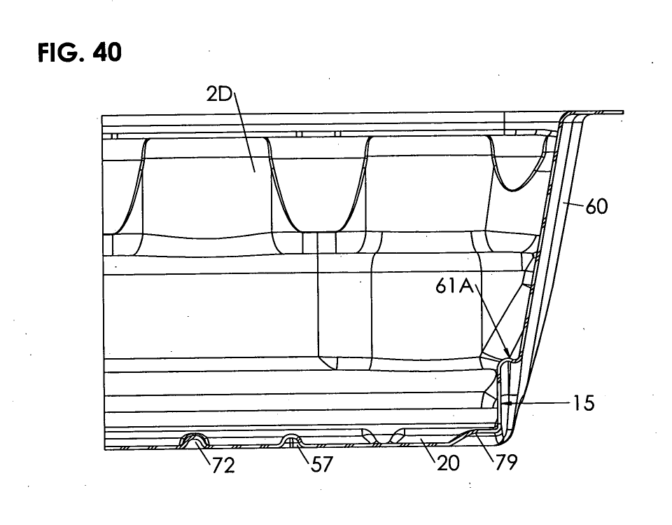

In contrast to FIGS. 36 and 37, FIGS. 38-40 are section views of gardening container 2D that further explain flow of nutrient/fluid through it. FIG. 38 is section view from the side of gardening container 2D shown main channel 20 extending between nutrient/fluid inlet opening 15 and nutrient/fluid drain/outlet opening 16, the downwardly-inclined ramps 79 and 79′ respectively adjacent to inlet and drain/outlet openings 15/16, the primary dam 57 situated between inlet opening 15 and main channel 20, a small nutrient/fluid diverting obstruction 72 positioned between dam 57 and drain/outlet opening 16, and the ledges in the sealing areas 61A above inlet and drain/outlet openings 15/16. FIG. 39 is an enlarged section view from the side of the drain/outlet end 59 of gardening container 2D that shows drain/outlet opening 16 in fluid communication with main channel 20, a small ramp 79′ downwardly-inclined toward main channel 20 situated adjacent to drain/outlet opening 16, and the ledge in the sealing area 61A above drain/outlet opening 16 that helps to seal the drain/outlet end 68 of the soil-blocking shield (14A-14C, or other) against end wall 59 of gardening container 2D to prevent soil infiltration into main channel 20. FIG. 40 is an enlarged section view from the side of the inlet end 60 of gardening container 2D that shows inlet opening 15 in fluid communication with main channel 20, a large downwardly-inclined ramp 79 adjacent to inlet opening 15, primary dam 57 in main channel 20 and situated close to inlet opening 15, the small nutrient/fluid diverting obstruction 72 positioned between dam 57 and drain/outlet opening 16, and the ledge in the sealing area 61A above inlet opening 15 that helps to seal the inlet end 68 of soil-blocking shield (14A-14C, or other) against the adjacent end wall of gardening container 2D to prevent soil infiltration into main channel 20.

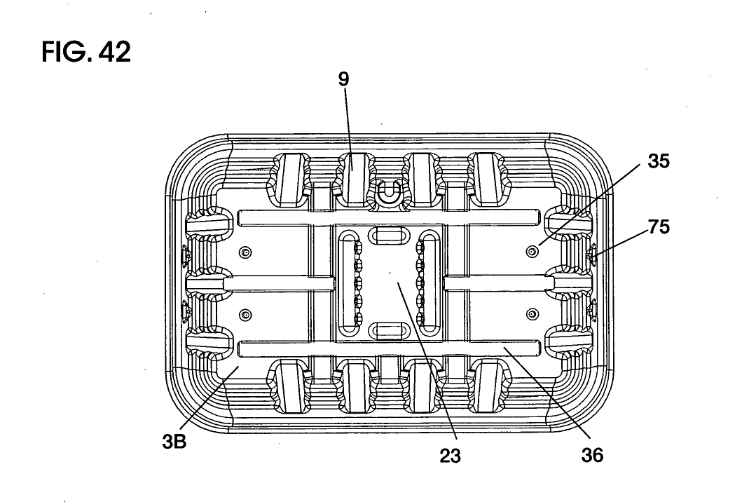

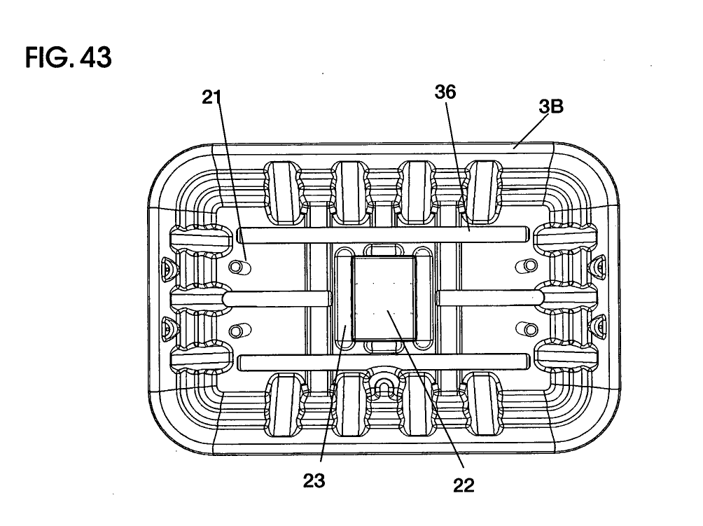

FIGS. 41-44 show a fifth preferred embodiment 1E of the present invention hybrid container-gardening system, with FIG. 41 showing the entirety of fifth preferred embodiment 1E and FIGS. 42-44 showing additional views of reservoir 3B. FIG. 41 is a perspective view from the side of three gardening containers 2D in fifth preferred embodiment 1E supported by frame 73 in stepped configuration that permits gravity-feed of nutrient/fluid from the gardening container 2D having the highest elevation and in succession to the gardening container 2D having the next highest elevation, with two reservoirs 3B positioned under gardening containers 2D. While the top of frame 73 has a substantially uniform elevation, the stepped configuration of gardening containers 2D that places each one at a different elevation is provided by the sculpted indentations 58A-58C in their side walls and a pair of horizontally-extending crossbar supports 74 each of which spaced apart from the other to correspond with the sculpted indentation 58A, 58B, or 58C that places the gardening container 2D at the needed height/elevation relative to adjacent gardening containers 2D and provide gravity-feed flow of nutrient/fluid from the highest gardening container 2D to the lowest one in succession before surplus nutrient/fluid is returned to reservoirs 3B for recycling. This stepped gravity-feed arrangement helps to overcome negative effects of uneven ground support that could otherwise impede optimal flow of nutrient/fluid through gardening containers 2D. Although nutrient/fluid inlet lines 8A-8C are not shown in FIG. 41 between gardening containers 2D and reservoirs 3B, they would be required for operation of fifth preferred embodiment 1E. For example, but not limited thereto, the three gardening containers 2D could have nutrient/fluid communication in stepped succession between adjacent ones thereof via a nutrient/fluid transport line 8B, the gardening container 2D having the highest elevation could be connected to one reservoir 3B via a nutrient/fluid inlet line 8A, the gardening container 2D having the lowest elevation could be connected to the other reservoir 3B via a nutrient/fluid return line 8C, and the two reservoirs 3B could have some type of fluid communication between them (optionally using knockout openings 10). In the alternative (but also not limited thereto), two of the gardening containers 2D could be connected to one reservoir 3B and the third gardening container 2D could be connected to the other reservoir 3B to be able to grow plants needing a higher nutrient content, or all three gardening containers 2D could be connected to one reservoir 3B, with the other reservoir prepared and ready for connection to the three gardening containers 2D when the plants therein enter a new growth phase with differing nutrient/fluid requirements. FIGS. 42-44 illustrate additional structure in reservoir 3B not visible in FIG. 41. FIG. 42 is a perspective view from the bottom of the reservoir 3B in fifth preferred embodiment 1E that shows the strength-enhancing structure 9 in the walls of reservoir 3B, lid supports 75 in the end wall of reservoir 3B that may also include a safety-enhancing locking feature to secure reservoir cover 4C in place and prevent access to reservoir 3B contents by pets or children, an alignment guide 23 integrated into the bottom surface of reservoir 3B and used to obtain secure positioning for a pump/filter unit 22, four attachment points 35 in the bottom surface of reservoir 3B that are used for securing the lower ends of gardening container supports 21, and strength-enhancing ribs 36 integrated into the bottom surface of reservoir 3B. Ribs 36 also help to interrupt heat conduction between the bottom surface of reservoir 3B and the ground, patio, or other surface supporting it to maintain a more moderate temperature for nutrient/fluid pumped to plant roots in gardening containers (2A-2E, or other). Although the size, shape, and positioning of strength-enhancing structure 9, lid supports 75, alignment guide 23, attachment points 35, and strength-enhancing ribs 36 shown in FIG. 42 is preferred for fifth preferred embodiment 1E, other embodiments also considered within the scope of the present invention may have strength-enhancing structure 9, lid supports 75, alignment guide 23, attachment points 35, and strength-enhancing ribs 36 with other sizes, shapes, and positioning. FIGS. 43 and 44 both view reservoir 3B from the top and show all four lid supports 75, alignment guide 23 for pump/filter unit 22, strengthened wall structure 9, and the strengthening ribs 36 in its bottom surface. In addition, FIG. 43 shows a pump/filter unit 22 secured in place by alignment guide 23 and four vertically-extending tubular gardening container supports 21 each having a lower end secured by a different one of the attachment points 35 shown in FIG. 44. FIG. 44 also shows the preferred height dimension of each of the four attachment points 35 and a knock-out 10 near the bottom surface of reservoir 3B used for the optional connection of a nutrient/fluid return line 8C. The size, configuration, and placement of attachment points 35 are not critical, and those providing any appropriate male or female connection may be used.

FIG. 45 is a side view of three gardening containers 2B in a sixth preferred embodiment 1F of the present invention hybrid container-gardening system that are supported by a frame 73 in a stepped configuration that permits gravity-feed of nutrient/fluid from the gardening container 2B having the highest elevation and in succession to the gardening container 2B having the next highest elevation, one large reservoir 3D positioned under the gardening containers 2B, and a reservoir cover 4E configured for placement/support of two additional gardening containers 2B (or other) at differing elevations. FIG. 45 also shows a nutrient/fluid inlet line 8A connected between reservoir 3D and the gardening container 2B having the highest elevation, additional nutrient/fluid inlet transport lines 8B connected between adjacent gardening containers 2B, and a nutrient/fluid return line 8C connected between the gardening container 2B having the lowest elevation and reservoir cover 4E. Frame 73 may provide at least part of the incline needed for gravity-feed of nutrient/fluid from one gardening container 2B to the next. FIG. 45 further shows rubber feet or other thermal insulator 17A secured to and supporting the bottom surface of reservoir 3D and a solar power generating unit 7 connected by a support 6 to frame 73. If appropriate to the location and plant growing needs, reservoir 3D can be moved out from under frame 73 so that additional gardening containers 2B (or other) can be used supported by reservoir cover 4E and nutrient/fluid lines 8A-8C can be connected as needed to the gardening containers (2B or other) supported by reservoir cover 4E. The number of gardening containers 2B supported by frame 73 is not limited to that shown in FIG. 45 as long as sufficient elevation can be achieved for proper gravity-feed of nutrient/fluid through all gardening containers 2B and return of surplus nutrient/fluid to reservoir 3D for recycling. Furthermore, depending on the size of gardening containers 2B, the number of gardening containers 2B used, and the type of plants to be cultivated therein, frame 73 may comprise sturdier supports and additional bracing beyond that shown in FIG. 45. In addition, FIG. 45 shows the stepped indentations 58D in the walls of reservoir 3D that add strength and rigidity to help prevent reservoir 3D from collapsing under the weight of any soil-filled gardening containers that it supports (2A-2E, or other).

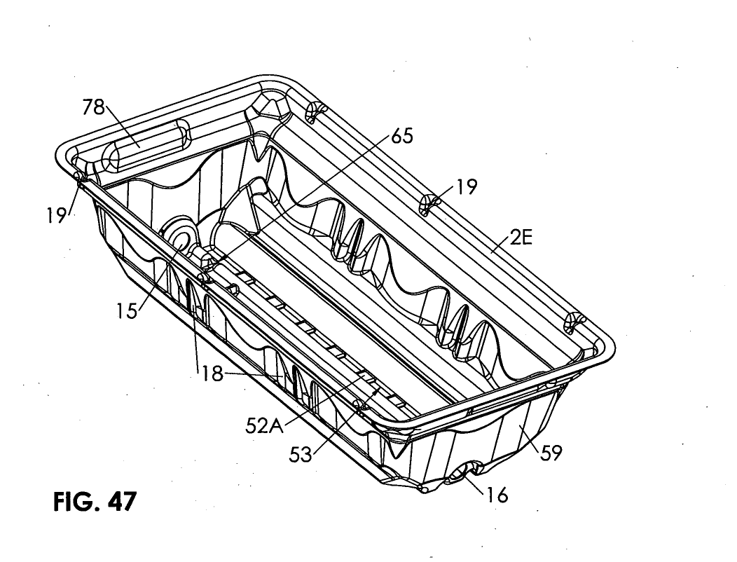

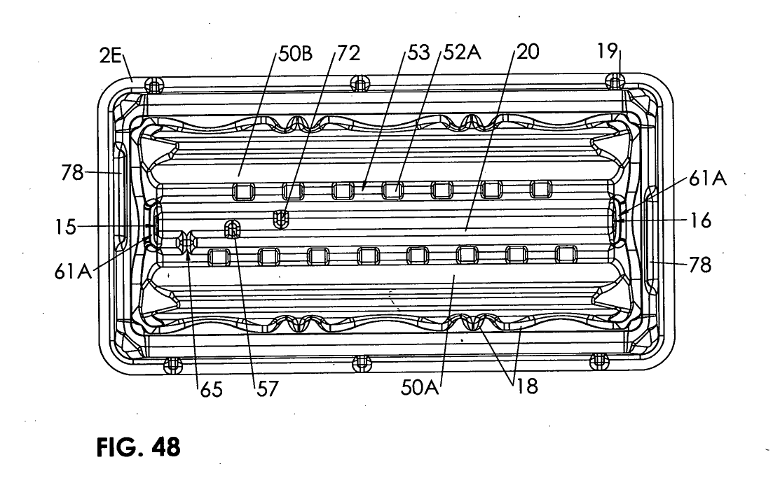

FIGS. 46-48 show a seventh preferred embodiment 1G of the present invention hybrid container-gardening system, with FIG. 46 showing the arrangement of gardening containers 2E and frames 76A and 76B in seventh preferred embodiment 1E and FIGS. 47-48 showing additional views of gardening container 2E. The modular form of seventh preferred embodiment 1G allows porch and balcony use, although other locations are also contemplated. When used outdoors, rainwater may supplement the filtered nutrient/fluid recycled into gardening containers (2E or other) that used as a part of seventh preferred embodiment 1G. However, provision for nutrient/fluid overflow due to excessive rain can also be included as a part of seventh preferred embodiment 1G, and once plants leaf out and start crop production, the speed of nutrient/fluid through gardening containers (2A-2E or other), can be increased to maintain optimum nutrient/fluid availability even though plant requirements have changed. FIG. 46 is a perspective view from the side of four gardening containers 2E supported by a modular frame (76A and 76B) in stepped configuration that permits gravity-feed of nutrient/fluid from the gardening container 2E having the highest elevation and in succession to the gardening container 2E having the next highest elevation, with additional modular frame units (not shown, but shorter or taller versions of 76B) easily connected to either end of modular frame 76A/76B as long as sufficient gravity-assist flow of nutrient/fluid through all gardening containers 2E can still take place. A simple bolted, easy-to-assemble, and strong frame 76A, with both of its end structures reaching the ground or other surface supporting it, may be used to support two substantially rectangular gardening containers 2E in a side-by-side stepped gravity-feed arrangement. It is also preferred, but not critical, for each frame 76B (having only one end structure reaching the ground or other support surface) to support two gardening containers (2E or other). The short end of the frame (76B′) can then be bolted or otherwise securely fixed to one end of frame 76A, or the longer end of another frame 76B as long as the connection creates the proper gravity-feed assist for nutrient/fluid flow within the gardening containers (2E or other) supported by frames 76A and 76B. Gardening containers 2E are then individually placed on the frame (76A, 76B, 73, and other) using the sculpted indentations 58A-58C in the sides of gardening containers 2E and crossbar supports 74 (see FIG. 41), crossbar supports 77, or other sturdy horizontally-extending support means. Leveling feet (not shown) may be added to frames (76A, 76B, 73, and other) to optimize gravity-feed of recycled nutrient/fluid within present invention systems. In addition, although not limited thereto, frames could be made from aluminum or steel coated with plastic to increase their corrosion resistance. Although not fully shown, nutrient/fluid line 8B would be required to placing gardening containers 2E in fluid communication with one another, and nutrient/fluid lines 8A and 8C also required to place gardening containers 2E in nutrient/fluid communication with a pump 40 in a reservoir (such as but not limited to reservoirs 3A-3D) to receive recycled nutrient/fluid for plant growth. If nutrient/fluid inlet line 8A is connected to the front of the gardening container 2E having the highest elevation, a nutrient/fluid transport line 8B would be connected to the drain/outlet opening 16 in the rear of the highest gardening container and the inlet opening 15 of the gardening container 2E adjacent to it. Such arrangement would place the drain/outlet opening 16 of the second highest gardening container 2E in the front, where a second nutrient/fluid transport line 8B would connect the front-positioned drain/outlet opening 16 of the second highest gardening container 2E to the front positioned inlet opening of the third highest gardening container 2E. The third and final nutrient/fluid transport line 8B would be connected behind the third and fourth gardening containers 2E, with the nutrient/fluid return line connected between the front-positioned drain/outlet opening 16 of the fourth gardening container 2E and a nutrient/fluid supply reservoir (3A-3D, or other). Insertable grommets can be easily used to connect nutrient/fluid transport lines 8B to gardening containers 2E, as they create a watertight seal and are compatible with various sizes of hose bib fittings, including elbows. Timers (not shown) and optional solar-assist (such as solar power generating unit 7) can also be used with the seventh preferred embodiment 1G. After sundown, timers are typically shut off, and the soil in gardening containers 2E acts like a sponge to prevent stagnant nutrient/fluid issues. Insulation on nutrient/fluid transport lines 8B connecting gardening containers 2E to one another is optional, but preferred in hotter climates to prevent super-heated nutrient/fluid from entering gardening containers 2E and preventing optimal growth of plant roots. Insulated nutrient/fluid transport lines 8B could also be of benefit in cooler climates to extend growing seasons. The nutrient/fluid supply reservoir (3A-3D, or other) used as a part of preferred embodiment 1G can be selected to contain a 30-day supply of nutrient/fluid, so that once the system is set up, the owner can walk away for 30 days with confidence that optimal system operation will continue.

FIGS. 47 and 48 show preferred structure in gardening containers 2E from the top. FIGS. 47 and 48 both show a gardening container 2E in the seventh preferred embodiment 1G having its nutrient/fluid inlet opening 15 in an opposed position from outlet opening 16 on its outlet end 59, strength-enhancing wall structure 18, three stand-off features 19 on each top edge that allow easy release of adjacent stacked gardening containers 2E from one another, opposed exterior indentation 78 on the upper portion of the ends of gardening container 2E that serve as hand-holds used for gardening container 2E lifting and transport, a nutrient/fluid access path 65 through which some nutrient/fluid entering gardening container 2E through its inlet opening 15 moves into a peripheral channel 50A or 50B, and the raised pads 52A and pockets 53 adjacent to a peripheral channel (50A or 50B) that provide a soil-fluid interface from which soil can slowly and consistently upwardly draw nutrient/fluid for later uptake by plant roots. Since gardening containers 2E have no basins 54 or 56 (see FIG. 14) and no ramps 79 or 79′ (see FIG. 37), leveling of gardening containers 2E in preferred embodiment 1G is more critical for proper nutrient/fluid flow therein and the slow and consistent uptake of nutrient/fluid by plant roots. In addition, FIG. 48 shows the main channel 20 extending between the nutrient/fluid inlet opening 15 and nutrient/fluid drain/outlet opening 16, one peripheral channel (50A and 50B) adjacent to each side of main channel 20, a primary dam 57 which slows travel of nutrient/fluid into main channel 20 and instead allows some of it to collect near inlet opening 15 for movement through access path 65 and otherwise into the peripheral channels 50A and 50B, and the ledges in sealing areas 61A above the inlet and drain/outlet openings 15/16 that assist in sealing the contact area between the end wall of gardening container 2E wall and one end 68 of the soil-blocking shield (14A, 14B, 14C, or other) to prevent soil infiltration into main channel 20. In addition, FIG. 48 shows a small nutrient/fluid diverting obstruction 72 positioned between dam 57 and drain/outlet opening 16 that slows nutrient/fluid flow through main channel 20 as well as peripheral channels 50A and 50B, creates a waterfall effect for recycled nutrient/fluid that adds oxygen to it to favor growth of plant roots, and also prevents too much from nutrient/fluid from jumping′upwardly into soil-filled areas, thus preventing overly fluid-saturated plant roots. Although only one nutrient/fluid diverting obstruction 72 is shown in FIG. 48, more than one nutrient/fluid diverting obstruction 72 may be used in seventh preferred embodiment 1G and other preferred embodiments of the present invention hybrid container-gardening system, particularly when nutrient/fluid access path 65 is not present to facilitate movement of nutrient/fluid into peripheral channels 50A and 50B. Furthermore, although not shown in FIG. 48, nutrient/fluid diverting obstructions 72 may be placed closer to drain/outlet opening 16 to slow nutrient/fluid flow through main channel 20. Also, structure positioned near the outlet ends of peripheral channels 50A and 50B allows nutrient/fluid to jump over it for exit from outlet opening 16, but not soil, thus preventing soil from clogging the nutrient/fluid transport lines 8B used for fluid communication between gardening containers (2A-2E or other). Limiting factors of seventh preferred embodiment 1G are the size and shape of the space available to house it (porch, balcony, back yard), the number of gardening containers (2A-2E or other) used and the vertical drop needed for good nutrient/fluid flow in the gravity-feed system from each gardening container (2A-2E or other) to the next lower gardening container (2A-2E or other), and the size of the pump 40 used for lifting the nutrient/fluid to the gardening container (2A-2E or other) having the highest vertical elevation. System advantages include consistent nutrients supplied to all plants for better plant growth and food production, no special nutrient/fluid conditioning supplies that are unavailable from local suppliers and expensive to purchase, and non-clogging nutrient/fluid flow that permits nutrient/fluid recycling.

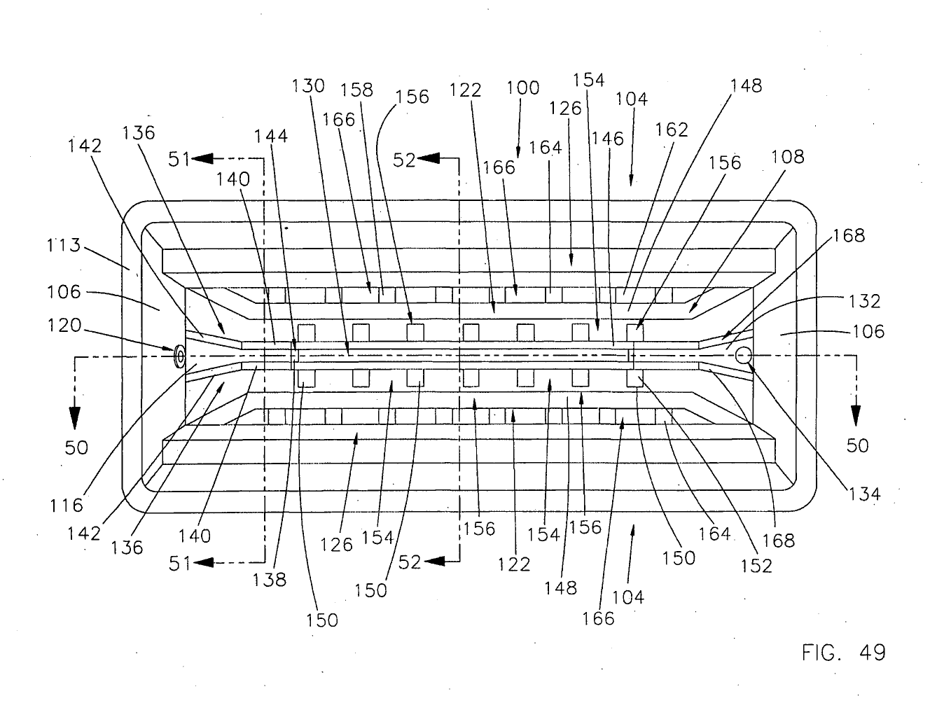

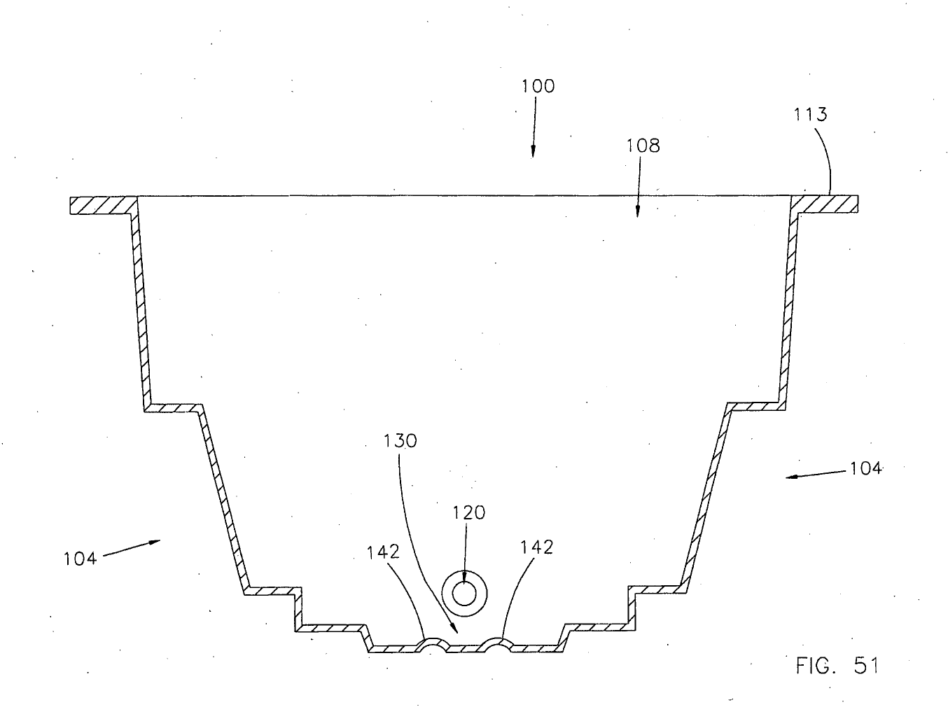

FIGS. 49 through 52 depict simplified views of a planter generally indicated as 100 previously described as a gardening container.

The planter 100 comprises a bottom 102 having a pair of stepped side walls each generally indicated as 104 connected at opposite ends by a pair of diagonally disposed end walls each indicated as 106 to cooperatively form a cavity 108 to retain soil 110 to support seedlings or plants each generally indicated 112 therein and to receive a nutrient/liquid solution to feed the root systems 114 of the seedlings or plants 112 with a nutrient/liquid solution through a fluid circulation system. Alternately, seeds (not shown) may be substituted for the plants or seedlings 112. An upper peripheral flange 113 is formed about the upper portions or edges of the pair of stepped side walls 104 and the pair of substantially diagonal end walls 106.

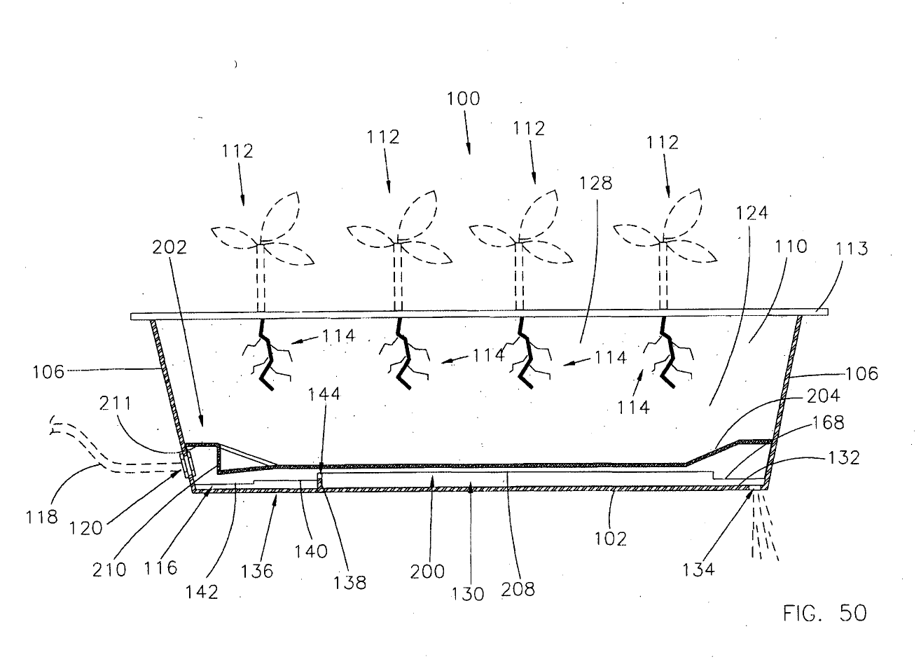

As shown in FIGS. 49 and 50, the fluid circulation system comprises an nutrient/liquid supply basin 116 coupled to a nutrient/liquid supply reservoir (not shown) through a nutrient/liquid supply conduit 118 and a nutrient/liquid supply hole or aperture 120 to receive a nutrient/liquid solution from the reservoir (not shown), a pair of primary nutrient/liquid supply troughs each generally indicated as 122 disposed to receive the nutrient/liquid solution from the nutrient/liquid supply basin 116 and to supply the nutrient/liquid solution to the lower portion 124 of the soil 110, a pair of secondary nutrient/liquid supply troughs each indicated as 126 to receive the nutrient/liquid solution from the lower portion 124 of the soil 110 by capillary action. The nutrient/liquid solution that is now on the lower portion 124 of the soil 110, migrates upward to the upper portion 128 of the soil 110 by evaporation. Specifically, evaporation occurs when heat is transmitted through the stepped side walls 104 and the substantially diagonal end walls 106 that are exposed to the ambient temperature.

Although the nutrient/liquid supply hole or aperture 120 is shown in the substantially diagonal end wall 106, the nutrient/liquid supply hole or aperture 120 may be formed in the bottom or floor of the nutrient/liquid supply basin 116.

The fluid circulation system further includes a centrally disposed nutrient/liquid solution excess overflow trough 130 disposed between the pair of primary nutrient/liquid supply troughs 122 and the pair of secondary nutrient/liquid supply troughs 126 to receive excess or overflow of nutrient/liquid solution from the nutrient/liquid supply basin 116 when the volume of nutrient/liquid flowing into the planter 100 from the nutrient/liquid supply conduit 118 exceeds the absorption rate of the lower portion 124 of the soil 110. In addition, a nutrient/liquid solution excess overflow run-off or drain surface 132 disposed as the distal end of the centrally disposed nutrient/liquid overflow trough 130 to receive overflow of nutrient/liquid solution from the nutrient/liquid overflow trough 130 and then through a nutrient/liquid drain hole or aperture 134 formed therethrough to drain excess or overflow nutrient/liquid solution from the gardening container or planter 100.

Alternately, the nutrient/liquid drain hole or aperture 134 may be formed in the end wall 106 adjacent the nutrient/liquid overflow run-off or drain surface 132.

As shown in FIGS. 49 and 50, the nutrient/liquid supply basin 116 comprises the end wall 106 having the nutrient/liquid supply hole or aperture 120 formed therethrough, a pair of basin side walls each generally indicated as 136 extending inwardly from the end wall 106 to separate the nutrient/liquid supply basin 116 and the primary nutrient/liquid supply trough 122 and an overflow or distal basin wall 138 connecting or extending between the distal end portions of the pair of basin side walls 136 to separate the nutrient/liquid supply basin 116 and the centrally disposed nutrient/liquid overflow trough 130. Each basin side wall 136 includes a distal wall portion 140 and a lower proximal wall portion 142 to supply the nutrient/liquid solution to each primary nutrient/liquid supply trough 122 as described hereinafter; while, the overflow or distal basin wall 138 includes a nutrient/liquid solution excess or overflow notch or opening 144 to allow excess nutrient/liquid solution accumulated in the nutrient/liquid supply basin 116 to overflow into the centrally disposed nutrient/liquid overflow trough 130 as described hereinafter.

Alternately, each basin side wall 136 may comprise a single height rather than the stepped height of the distal wall portion 140 and the lower proximal wall 142. Similarly, the overflow wall 138 may comprise a single height without the nutrient/liquid solution excess or overflow notch or opening 144.

As best shown in FIGS. 49 and 52, each primary nutrient/liquid supply trough 122 comprises a longitudinally disposed inner wall 146 and a longitudinally disposed outer wall 148 extending upwardly from the bottom 102 and having a plurality of primary upwardly extending protrusions or ribs each indicated as 150 including an upper surface 152 extending diagonally downward from the longitudinally disposed inner wall 146 to the bottom 102 in spaced relationship relative to the longitudinally disposed outer wall 148 to cooperatively for a plurality of primary supply pockets or recesses each indicated as 154 formed between adjacent primary upwardly extending protrusions or ribs 150 and a nutrient/liquid supply channel 156 adjacent the longitudinally disposed outer wall 148 and extending substantially the length of the primary nutrient/liquid supply trough 122 to supply nutrient/liquid solution to the plurality of supply pockets or recesses 154 from the nutrient/liquid supply basin 116.

As best shown in FIGS. 49 and 52, each secondary nutrient/liquid supply trough 126 comprises a longitudinally disposed inner wall 158 which may be an extension of the longitudinally disposed outer wall 148 of the primary nutrient/liquid supply trough 122 and a longitudinally disposed outer wall 160 extending upwardly from a bottom wall 162 and having a plurality of secondary upwardly extending protrusions or ribs each indicated as 164 extending between the longitudinally disposed inner wall 158 and the longitudinally disposed outer wall 160 to cooperatively form a plurality of secondary supply pockets or recesses each indicated as 166 between adjacent secondary upwardly extending protrusions or ribs 164 to receive the nutrient/liquid solution from the soil 110 below.

The centrally disposed nutrient/liquid overflow trough 130 is cooperatively formed by the overflow or distal basin wall 138 and the substantially parallel, longitudinally disposed inner walls 146 emptying onto the nutrient/liquid overflow run-off drain surface 132 and out of the nutrient/liquid drain hole or aperture 134. The distal portion of each longitudinally disposed inner wall 146 adjacent the nutrient/liquid overflow run-off drain surface 132 includes a notch or opening 168 to allow the flow of nutrient/liquid solution not absorbed by the soil 110 to flow from either of the primary nutrient/liquid supply troughs 122. Alternately, the substantially parallel, longitudinally disposed inner walls 146 may terminate at the nutrient/liquid overflow run-off drain surface 132 without the notch or openings 168. Nutrient/liquid solution then flows to the nutrient/liquid drain hole or aperture 134 to drain excess or overflow nutrient/liquid solution from the garden container or planter 100.

The centrally disposed nutrient/liquid overflow trough 130 and inner portions of each primary nutrient/liquid supply trough 122 are covered by a soil support cover 200. The soil support cover generally indicated as 200 separate the soil 110 from the centrally disposed nutrient/liquid overflow trough 130, nutrient/liquid supply basin 116, and nutrient/liquid run-off or drain surface 132.

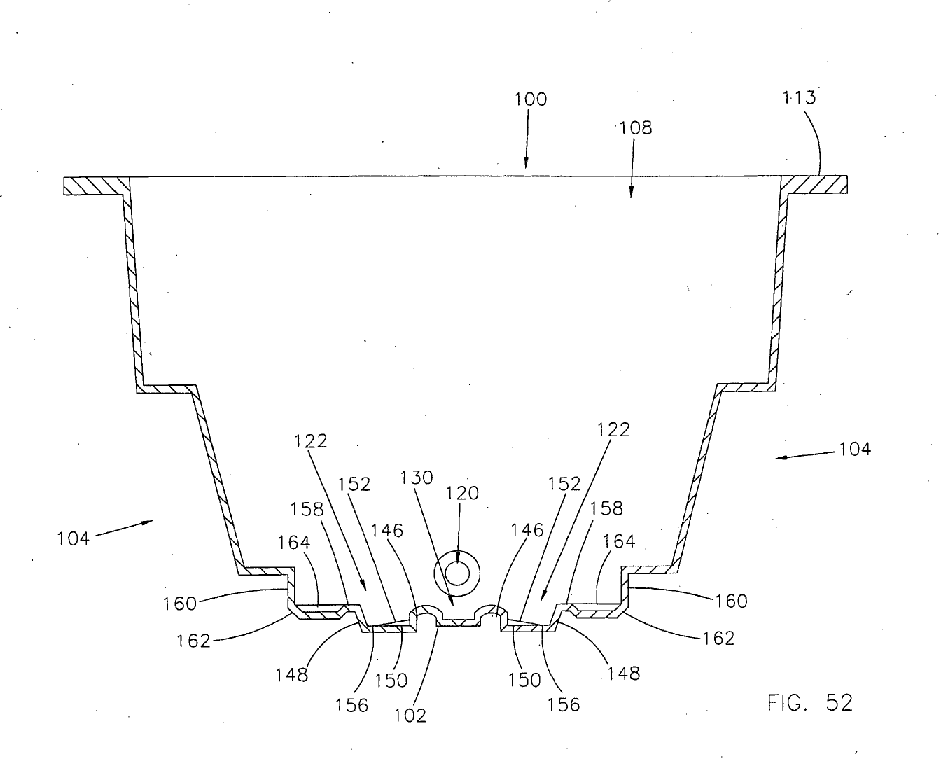

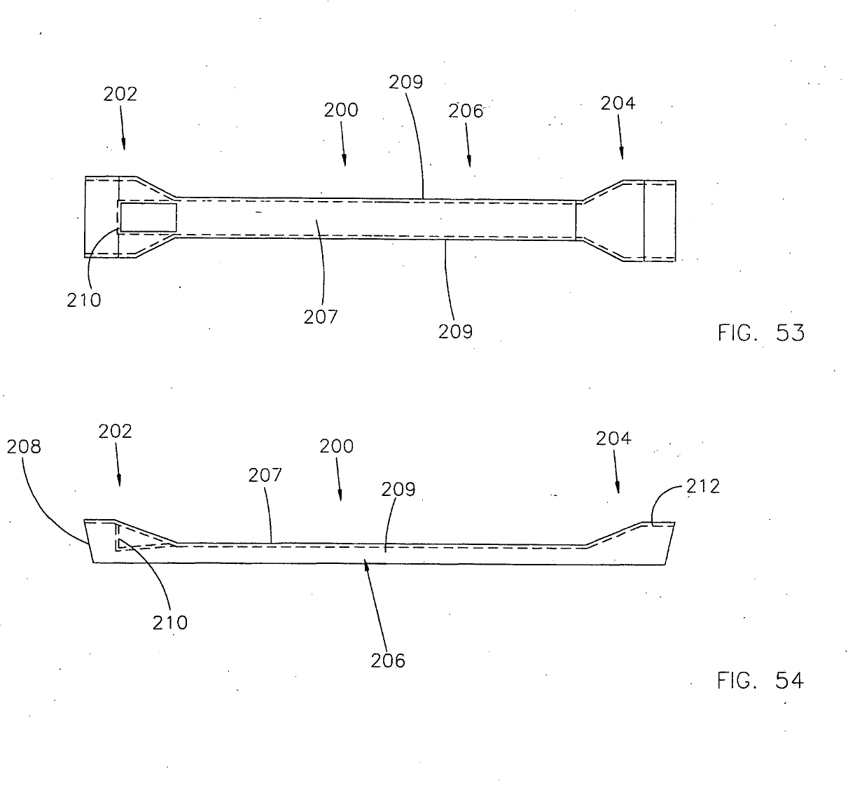

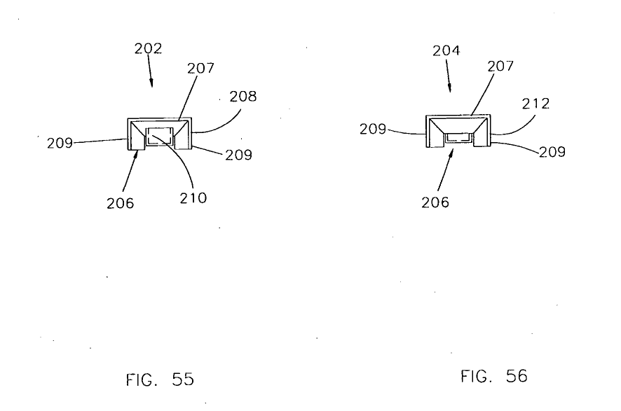

FIGS. 53 through 56 show the soil support cover 200 to cover and to separate the soil 110 from the nutrient/liquid supply basin 116, the centrally disposed nutrient/liquid overflow trough 130, and nutrient/liquid run-off or drain surface 132. The soil support cover 200 comprises an elongated inverted trough 206 including an elongated upper wall 207 having an elongated support side wall 209 extending downwardly from each side therefrom supported in spaced relationship relative to the centrally disposed nutrient/liquid overflow trough 130 by a ledge 211 (FIG. 50) extending inwardly from the substantially diagonal end wall 106 and the elongated support side walls 209 resting on or engaging the upper surface 152 of the plurality of upwardly extending protrusions or ribs 150.

The soil support cover 200 further comprises supply basin cavity generally indicated as 202 and a run-off drain surface cavity generally indicated as 204 to cover the nutrient/liquid supply basin 116 and the nutrient/liquid overflow run-off or drain surface 132 respectively. A substantially vertical deflector 210 extends downwardly within the supply basin cavity 202 adjacent the nutrient/liquid supply hole or aperture 120 to diffuse and oxygenate the nutrient/liquid solution supplied through the nutrient/liquid supply hole or aperture 120 to the nutrient/liquid supply basin 116.

When the planter or gardening container 100 is integrated into the previously described gardening system, solar energy may be collected by the solar panel to power the circulating pump. No extension cord or home power source is ever needed thereby reducing the risk of electrical shock.

The nutrient/liquid solution is pumped (recirculated) into the planter or gardening container 100. The elevated height of the planter or gardening container 100 prevents weeds and garden pests from entering the soil 110 or plants 112 thereby eliminating the need for harmful pesticides and herbicides.

The nutrient/liquid solution circulating through the planter or gardening container 100 is delivered through the primary nutrient/liquid supply trough 122 and secondary nutrient/liquid supply trough 126 to the soil 110 and directly to the root systems 114 while reducing root rot, fungus and disease. The flow of oxygenated nutrient/liquid solution also absorbs and transfers excess heat from of the planter or gardening container 100 to reduce temperatures resulting in less root stress to plants 112 and water savings as compared to traditional container gardens.

The primary nutrient/liquid supply trough 122, secondary nutrient/liquid supply trough 126 and centrally disposed nutrient/liquid overflow trough 130 may be inclined downwardly from the nutrient/liquid supply hole or aperture 120 and the nutrient/liquid supply basin 116 to the nutrient/liquid overflow run-off drain surface 132 and the nutrient/liquid drain hole or aperture 134, the nutrient/liquid solution flows or circulates through the planter or gardening container 100 by the force of gravity preventing over-watering plants and stagnant water which can lead to disease from sitting at the bottom of the container.

The nutrient/liquid solution can flow back into the reservoir to re-oxygenate by natural aeration. A 32 gallon capacity reservoir ensures the gardening system can operate for weeks without the need to replenish the liquid (water). In addition, water soluable nutrient can be added directly into the reservoir.

Finally, the reservoir can also act as a heat sink to maintain a relative constant temperature resulting in less stress to the root systems 114. This can reduce plant damage due to excessive heat or cold.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A planter to supply a nutrient/liquid solution to the root systems of plants or seedlings planted in soil retained within said planter, said planter comprises a bottom having a pair of side walls connected at opposite ends by a pair of end walls extending upwardly therefrom to cooperatively form a cavity to retain the soil to support seedlings or plants therein and to receive a nutrient/liquid solution, to feed the root systems of the seedlings or plants with a nutrient/liquid solution through a fluid circulation system; said fluid circulation system comprises an nutrient/liquid supply aperture formed in the proximal end of said planter coupled to a nutrient/liquid supply to receive the nutrient/liquid solution from the nutrient/liquid supply source and at least one primary nutrient/liquid supply trough to receive the nutrient/liquid solution from said nutrient/liquid supply aperture to supply the nutrient/liquid solution to the lower portion of the soil and a primary nutrient/liquid supply trough comprising a longitudinally disposed inner wall and a longitudinally disposed outer wall extending upwardly from said bottom and having a plurality of primary upwardly extending protrusions including an upper surface in spaced relationship relative to said longitudinally disposed outer wall to cooperatively for a plurality of primary supply recesses formed between adjacent primary upwardly extending protrusions and a nutrient/liquid supply channel extending substantially the length of said primary nutrient/liquid supply trough to supply nutrient/liquid solution to said plurality of supply recesses from said nutrient/liquid supply aperture and a nutrient/liquid drain aperture formed in the distal end of said planter to drain excess nutrient/liquid solution from said planter.

2. The planter of claim 1 wherein said fluid circulation system comprises a pair of substantially parallel primary nutrient/liquid supply troughs.

3. The planter of claim 2 wherein said fluid circulation system further includes a centrally disposed overflow trough disposed between said pair of substantially parallel primary nutrient/liquid supply troughs to receive nutrient/liquid solution therefrom when the volume of nutrient/liquid flowing through said planter exceeds the absorption rate of the of the soil.

4. The planter of claim 3 wherein said centrally disposed nutrient/liquid overflow trough is cooperatively formed between said longitudinally disposed inner walls of said pair of substantially parallel primary nutrient/liquid supply troughs.

5. The planter of claim 4 further including a soil cover to support the soil therein and separate the soil from said nutrient/liquid supply aperture, said centrally disposed nutrient/liquid overflow trough and said nutrient/liquid solution drain aperture.

6. The planter of claim 5 further including a pair of substantially parallel secondary nutrient/liquid supply troughs to receive nutrient/liquid solution from the lower portion of the soil, each said second nutrient/liquid supply trough is cooperatively formed by said longitudinally disposed outer wall of said corresponding primary nutrient/liquid supply trough and a secondary longitudinally disposed outer wall extending upwardly from said bottom wall having a plurality of secondary upwardly extending protrusions extending between said longitudinally disposed outer wall of said corresponding primary nutrient/liquid supply trough and said secondary longitudinally disposed outer wall to cooperatively form a plurality of secondary supply recesses between adjacent secondary upwardly extending protrusions to receive the nutrient/liquid solution from the soil below.

7. The planter of claim 5 wherein said soil support comprises an elongated inverted trough including an elongated upper wall having an elongated support side wall extending downwardly from each side therefrom supported in spaced relationship relative to the centrally disposed nutrient/liquid overflow trough.

8. The planter of claim 7 wherein said soil support further comprises a deflector extending downwardly from said elongated upper wall adjacent said nutrient/liquid supply aperture to diffuse the nutrient/liquid solution supplied through said nutrient/liquid supply aperture.

9. The planter of claim 8 wherein said elongated support side walls rests on or engages said upper surface of said plurality of primary upwardly extending protrusions.

10. The planter of claim 9 wherein each said upper surface slants downwardly from said longitudinally disposed inner wall to said nutrient/liquid supply channel.

11. The planter of claim 3 wherein said fluid circulation system further comprises a nutrient/liquid supply basin disposed between said nutrient/liquid supply aperture and said substantially parallel supply troughs to supply nutrient/liquid solution from the nutrient/liquid solution supply source to the substantially parallel pair of primary nutrient/liquid supply troughs.

12. The planter of claim 11 wherein said nutrient/liquid supply basin comprises the proximal end wall of said planter, a pair of basin side walls extending inwardly from said end wall to separate said nutrient/liquid supply basin and said primary substantially parallel nutrient/liquid supply troughs and an overflow basin wall connecting the distal end portions of said pair of basin side walls to separate said nutrient/liquid supply basin and said centrally disposed nutrient/liquid overflow trough.

13. The planter of claim 12 wherein said basin side wall includes an upper distal wall portion and a lower proximal was portion to supply the nutrient/liquid solution to each of said substantially parallel primary nutrient/liquid supply troughs.

14. The planter of claim 13 wherein said overflow basin wall includes a nutrient/liquid solution overflow notch to allow excess nutrient/liquid solution accumulated in said nutrient/liquid supply basin to overflow into said centrally disposed nutrient/liquid overflow trough.

15. The planter of claim 12 wherein the height of each said basin side wall is less than the height of said overflow basin wall.
